(19) United States
(12) Patent Application Publication
(10) Pub. No.: US 2005/0055394 A1
(43) Pub. Date: Mar. 10, 2005

(54) Method and system for high performance, multiple-precision multiply-and-add operation

(76) Inventor: John S. Worley, Fort Collins, CO (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/659,837

(22) Filed: Sep. 10, 2003

(51) Int. Cl. G06F 7/38

(52) U.S. Cl. 708/523

(57) ABSTRACT

A method and system for execution of high performance, multiple-precision multiply-and-add operations that take advantage of native multiply-and-add instruction of modem processors. A careful choice of instruction ordering leads to highly parallelizable groups of instructions, the instructions in each group independent of the results generated by other instructions of the group.

### TECHNICAL FIELD

The present invention relates to arithmetic operations carried out by computer systems.

### BACKGROUND OF THE INVENTION

The hardware architectures of early computers were initially simple and constrained. Early computer architectures included simple move instructions for moving data between registers and between registers and memory, integer add instructions, various additional instructions that allowed the contents of a register to be complemented, and various test and branch instructions. Subsequent computer architectures included more complex instruction sets, including integer multiply instructions, floating point instructions, complex vector and multiple-precision instructions, and various complex special-purpose instructions. These subsequent computer architectures were based on extensive microcode implementation of complex instructions. Still later, a class of simplified computer architectures, commonly referred to as reduced-instruction-set-computing (“RISC”) architectures, were developed to facilitate creation of much faster processors, offloading the burden of complex calculations and special-purpose instructions to the increasingly powerful complier technologies that developed, in parallel, with computer hardware.

Hardware processor development has continued to produce newer classes of computer architectures that, among other things, provide for 64-bit address spaces and a 64-bit fundamental computational unit, or natural word size. The Intel Itanium® architecture is an example of this newer class of 64-bit processor architectures. The family of architectures that include the Intel Itanium® architecture is referred to as the explicitly-parallel-instruction-computing (“EPIC”) architecture. This architecture provides for much greater parallelism in instruction execution, but depends on complier support for explicitly grouping and ordering instructions in order to take advantage the parallelism provided by the underlying hardware. Although not generally classified as a RISC architecture, the Intel Itanium® architecture, and other similar modem processor architectures, continue to feature fairly simple instruction sets to facilitate processor speed and to facilitate pipelining.

Modem computer systems, including modem operating systems, are becoming increasingly dependent on cryptography for securing operating systems and operating-system kernels, for securing transfer of data between different computational entities, and for securing access to computing resources. Many cryptographic methodologies depend, in turn, on efficient and fast arithmetic operations carried out by modem processors in order to compute, for example, encryption keys, to decrypt encrypted messages, and to encrypt plain-text data and information.

A fundamental arithmetic operation important in a number of cryptographic methodologies is the multiple-precision multiply-and-add operation. FIGS. 1A-C illustrate one particular example of a multiply-and-add operation. In FIG. 1A, the maximum-sized unit of data that can serve as an operand for an arithmetic operation, such as an add or multiply machine instruction, is shown as a small unfilled rectangle, such as rectangle 102. In general, this maximum-sized unit is either the natural word size for the computer, or twice the natural word size. In early computer systems, this maximum-sized unit was often a byte. In the Intel Itanium® processor architecture, this maximum-sized unit is generally a 64-bit word. A series of maximum-sized computational units may be combined to form larger numbers, just as, in natural arithmetic, a series of digits representing the values 0-9 can be combined to form larger numbers.

A multiple-precision operation is an operation in which one of more of the operands are numbers larger than can be expressed by the natural word size of the computer, or, in other words, numbers represented by a set of a natural words, rather than a single natural word. Most commonly, a multiple-precision number is represented by a set of natural words contiguous in memory and therefore having monotonically increasing natural-word addresses, or by several registers. In the example multiple-precision multiply-and-add operation shown in FIG. 1A, a four-natural-word operand y 104, comprising four contiguous natural words 102 and 106-108, is multiplied by the four-natural-word operand x 110, and the eight-natural-word operand a 112 is then added to the result of the multiplication of operands x and y to produce a result 114 that may need up to nine natural words in order to accommodate the maximum result from a four by four natural-word multiplication followed by addition of an eight-natural-word addend. It should be noted that this example multiple-precision multiply-and-add operation, employed throughout the discussion of the present invention, is merely one example of an almost limitless number of different multiply-and-add operations. For example, the number of natural words used to represent any or all of the operands x, y, and a and the result may vary. Only one operand need be larger than the natural-word size for a multiply-and-add operation to be regarded as a multiple-precision operation.

In the following discussion, numerical values for the operands x, y, and a, and for the result are used in order to clearly describe the present invention. FIG. 1B shows the numerical values for the operands in result in hexadecimal representation, and FIG. 1C shows the numerical values for the operands in result in decimal representation. In the example illustrated in FIGS. 1A-C, and used throughout the following discussion, the natural word size is assumed to be one byte, or eight bits, for simplicity of calculation and illustration. Again, however, the techniques of the present invention are applicable to multiple-precision multiply-and-add operations regardless of the natural word size of the computer on which they are implemented.

When the operands in result can each be expressed in a single natural word, a multiply-and-add operation can generally be carried out by execution of one or a few architecture-provided machine instructions. However, a multiple-precision multiply-and-add operation is more complex, and requires execution of a number of underlying hardware-provided machine instructions in a proper order. Because the multiple-precision multiply-and-add operation is fundamental to many modern cryptographic methodologies, and because the cryptographic methodologies are becoming increasingly important and increasingly used in modem operating systems and applications, designers, manufacturers, and users of modem computer systems have recognized the need for high performance, highly efficient multiple-precision multiply-and-add operations that take full advantage of the instruction sets and performance capabilities of the processors on which these multiple-precision multiply-and-add operations execute.

### SUMMARY OF THE INVENTION

One embodiment of the present invention is a high performance, multiple-precision multiply-and-add operation that takes advantage of native multiply-and-add instruction of a modern processor. A careful choice of instruction ordering leads to highly paralizable groups of instructions, the instructions in each group independent of the results generated by other instructions of the group.

### BRIEF DESCRIPTION OF THE DRAWINGS

FIGS. 1A-C illustrate one particular example of a multiply-and-add operation.

FIGS. 2A-N illustrate a straightforward implementation of a multiple-precision, multiply-and-add operation.

FIGS. 3A-J illustrate an implementation of a multiple-precision multiply-and-add that is more computationally efficient that the implementation illustrated in FIGS. 2A-N.

FIGS. 4A-K illustrate execution of an embodiment of a multiple-precision multiply-and-add operation.

### DETAILED DESCRIPTION OF THE INVENTION

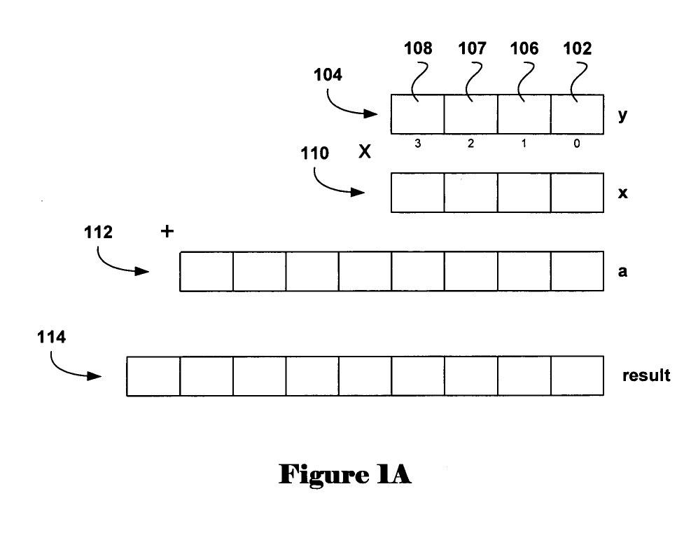

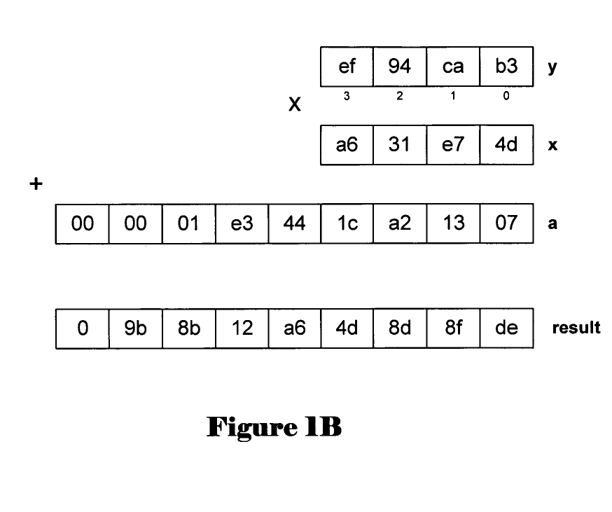

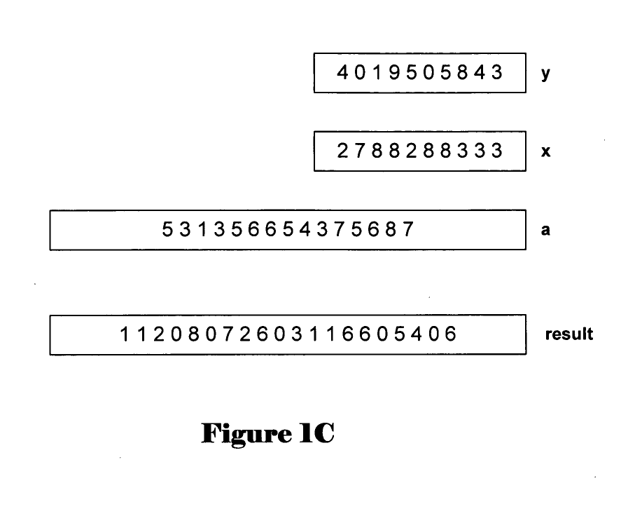

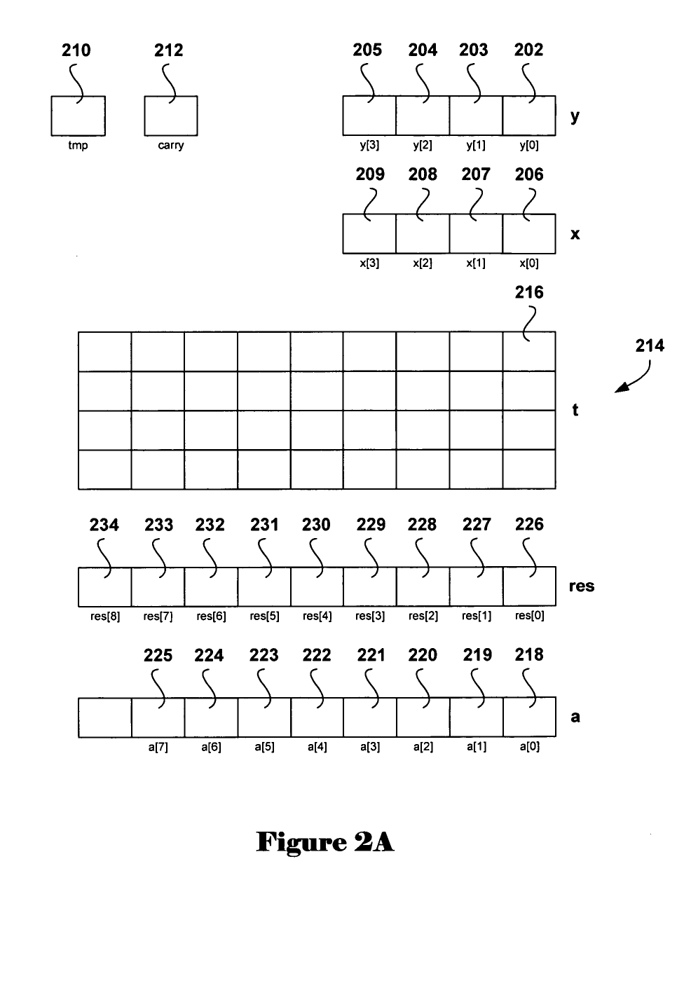

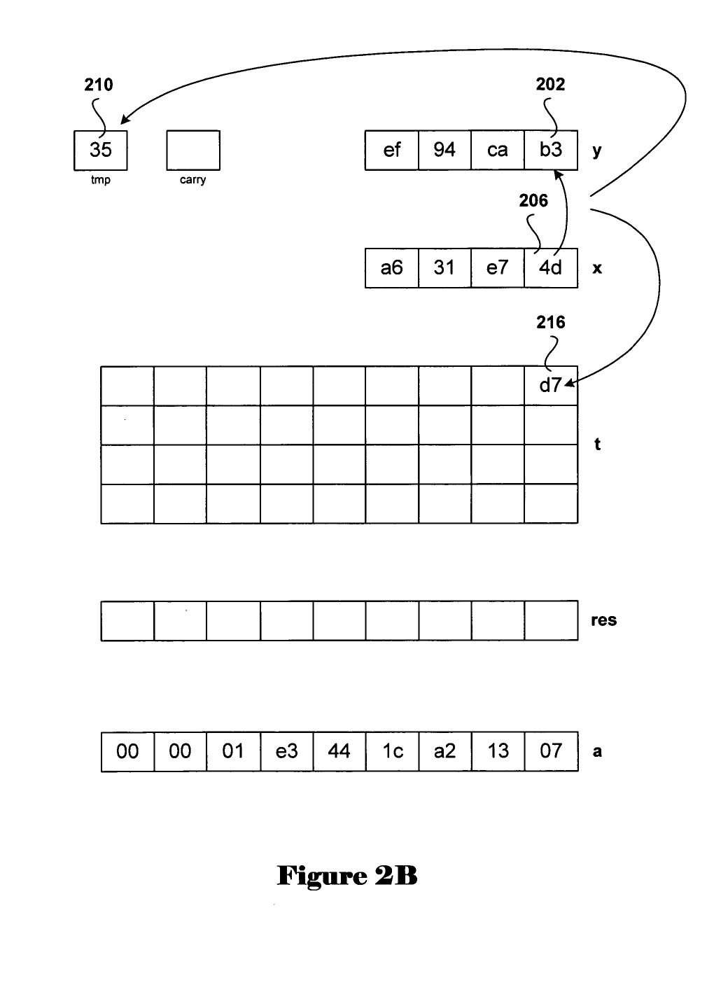

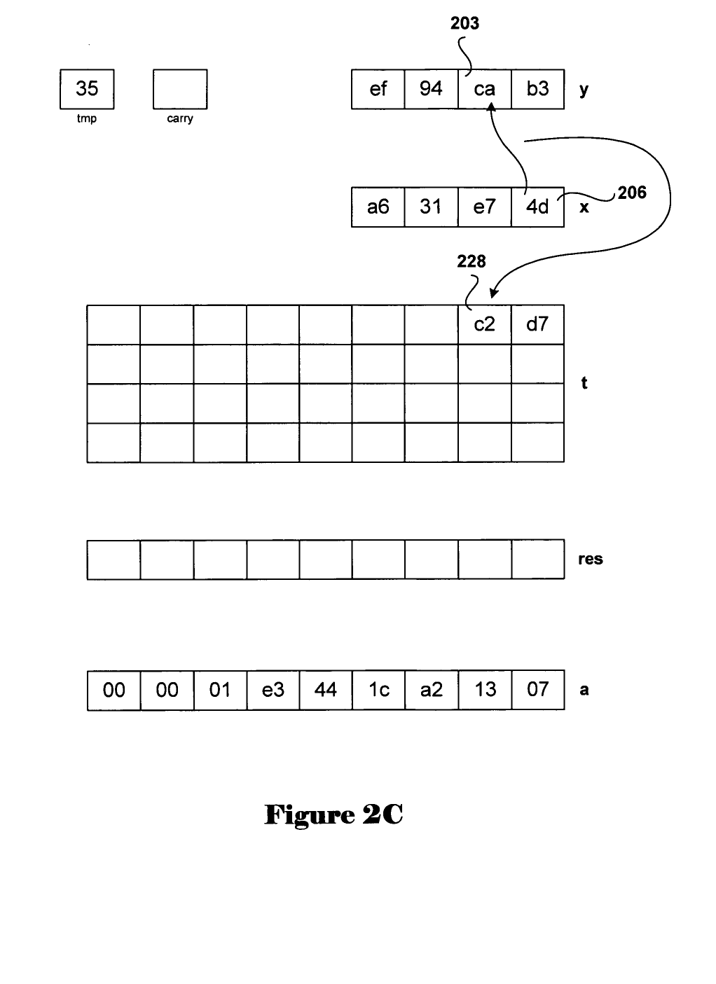

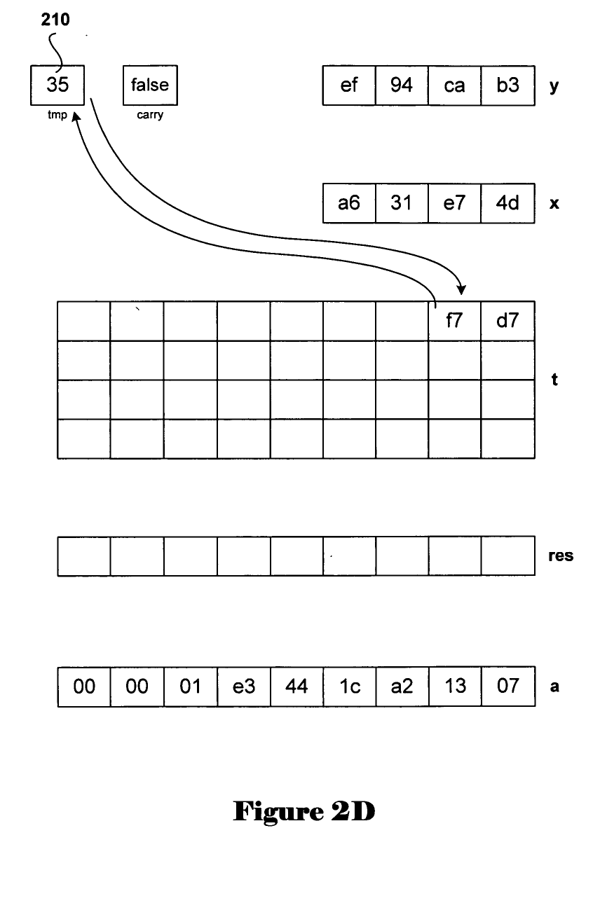

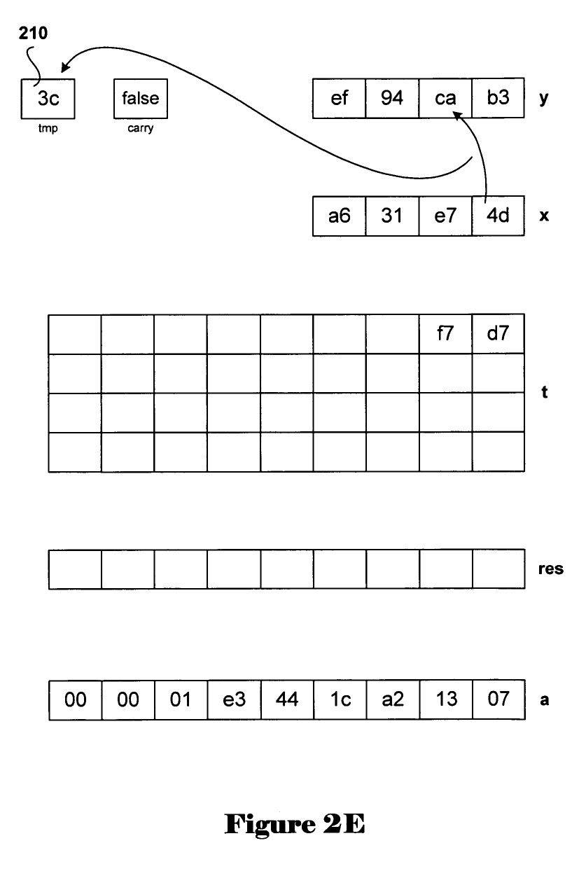

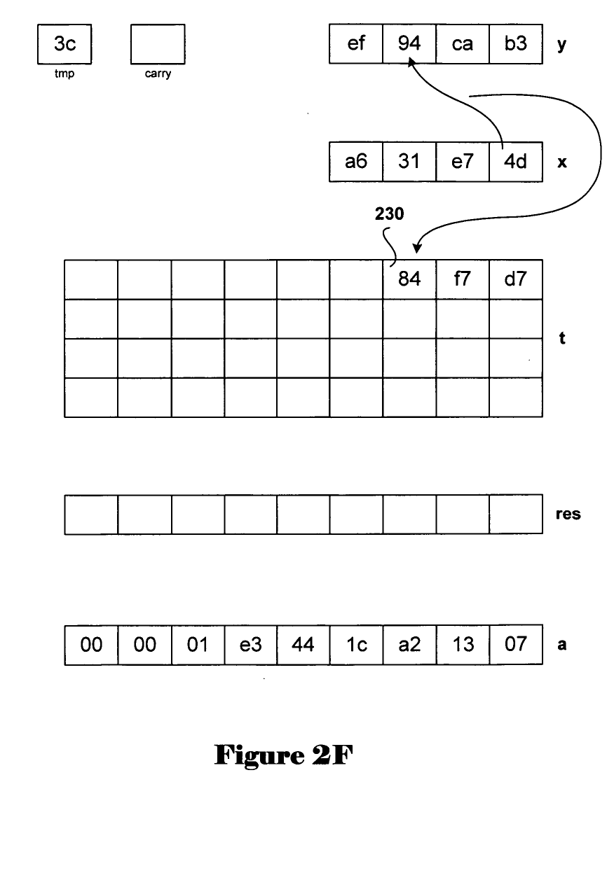

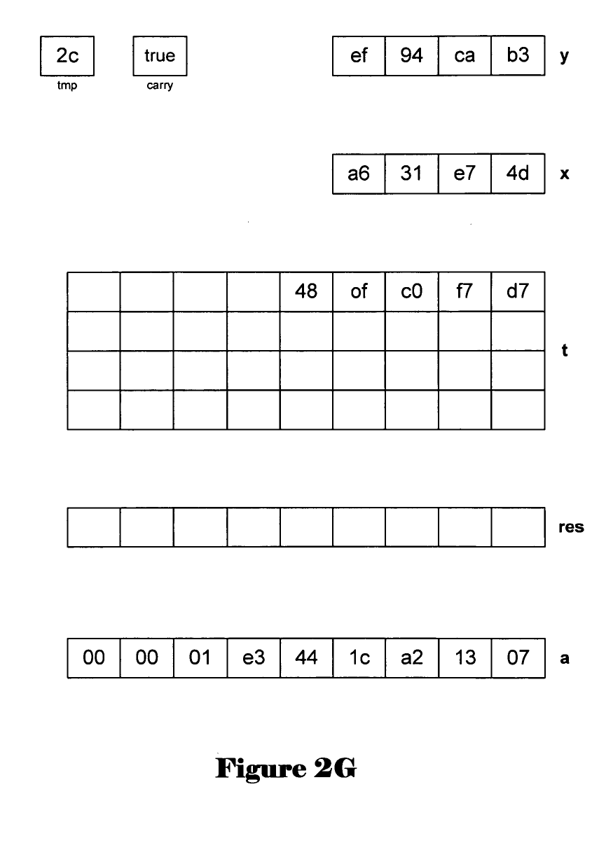

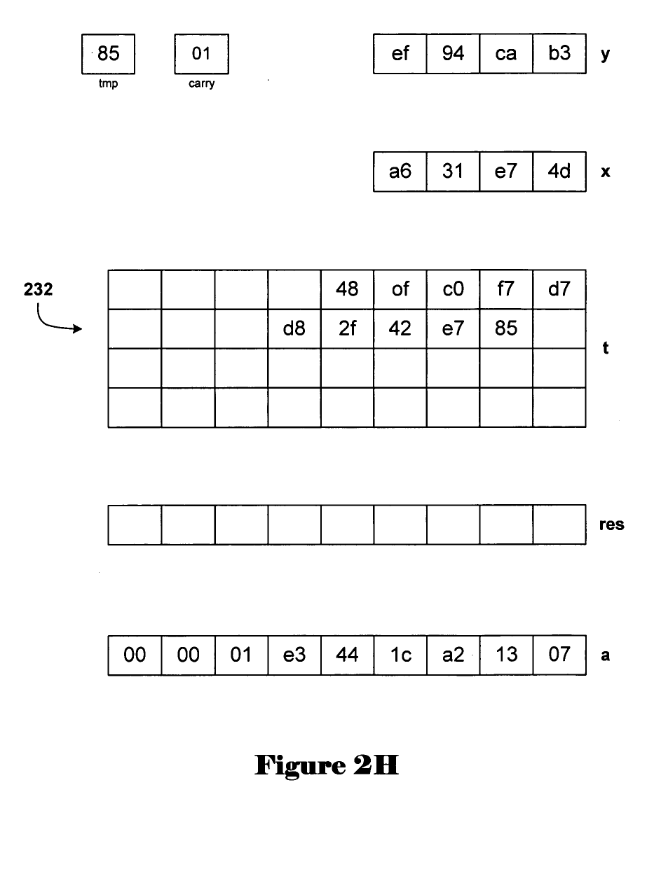

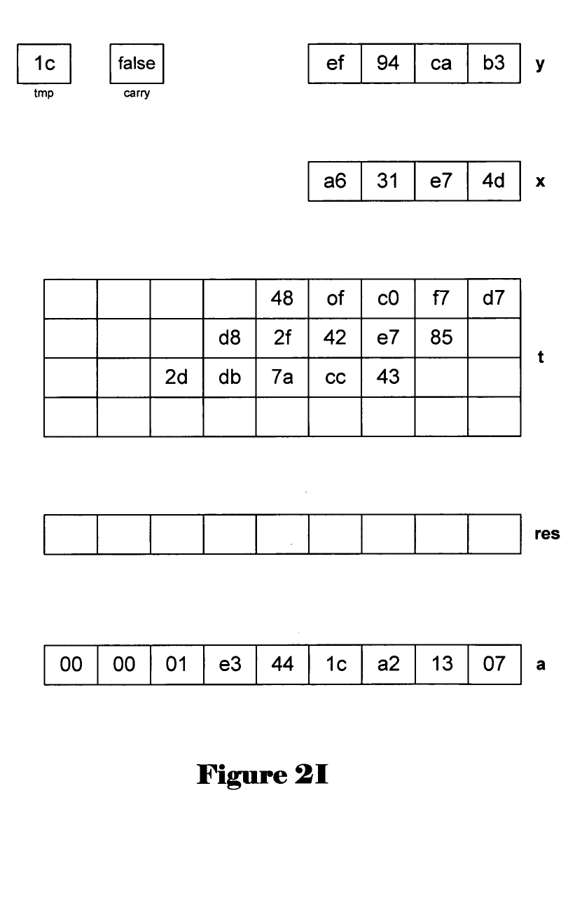

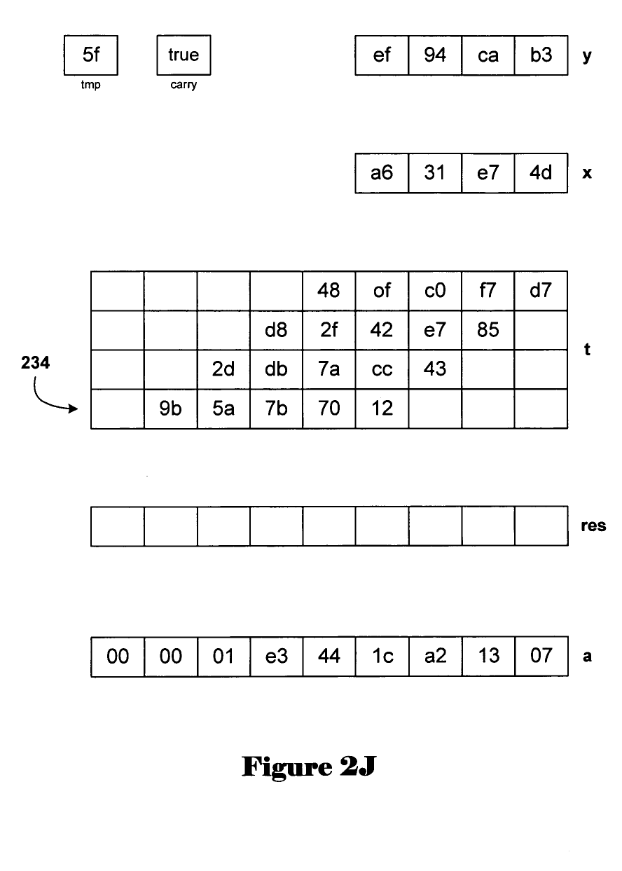

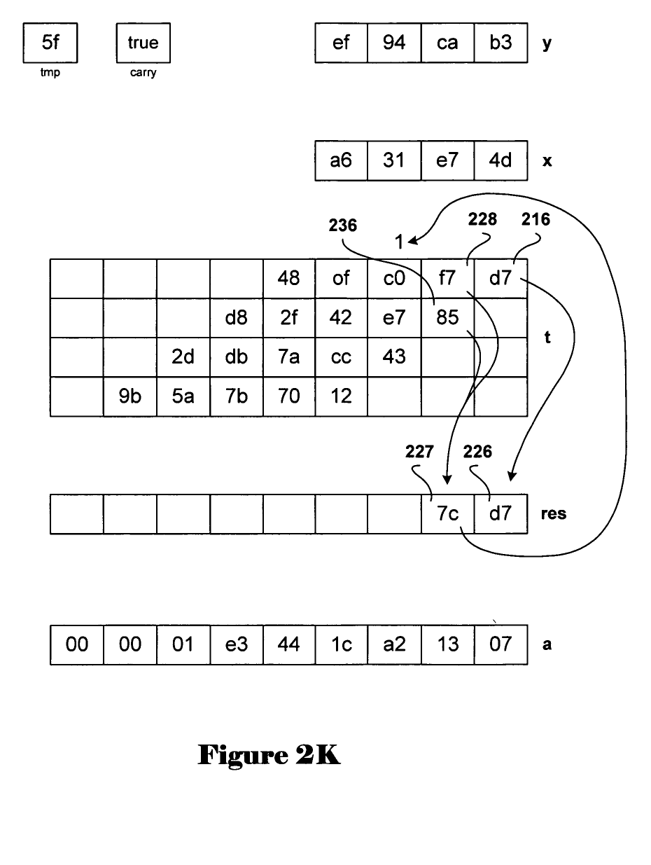

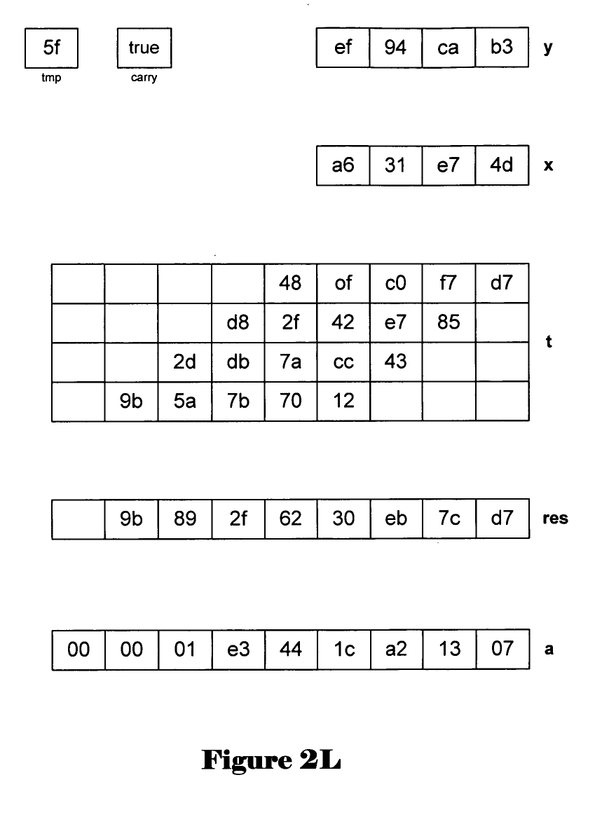

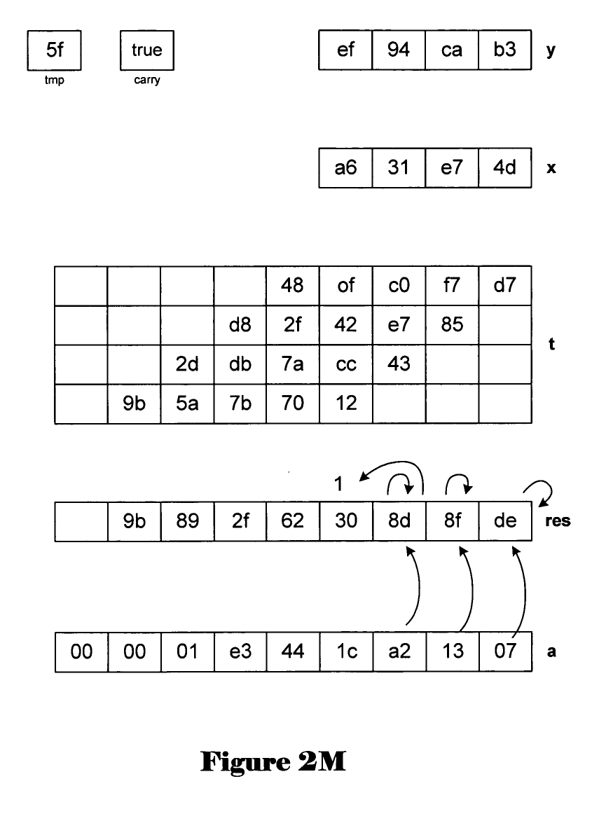

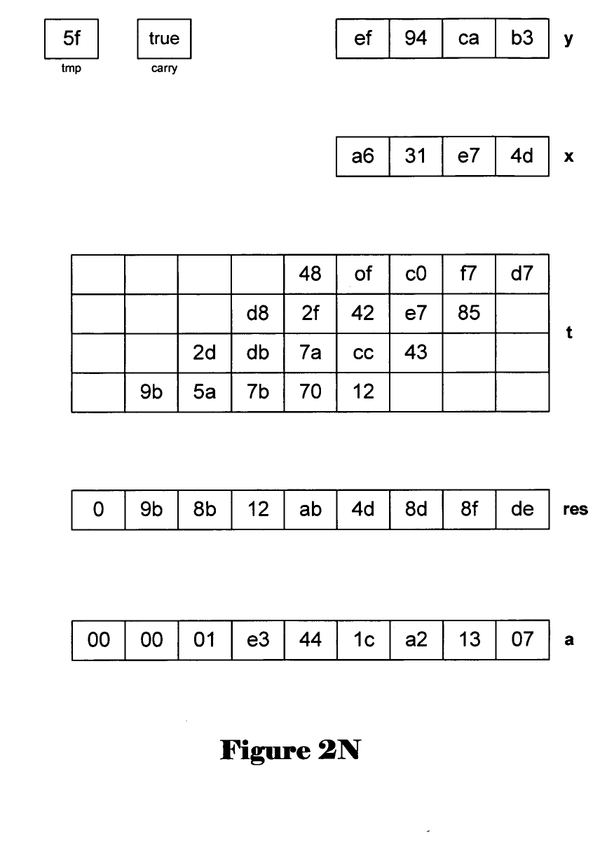

There are a number of different approaches to implementing a multiple-precision multiply-and-add operation. Perhaps the most straightforward approach is an approach that mirrors the standard, longhand-multiplication and longhand-addition methods learned by elementary-school students. FIGS. 2A-N illustrate a straightforward implementation of a multiple-precision, multiply-and-add operation. These figures are all based on the numerical example illustrated in, and described with reference to, FIGS. 1A-C. In addition, a short C++-like pseudo-code implementation of this first, straightforward implementation of a multiple-precision multiply-and-add operation is provided below, and is referenced along with FIGS. 2A-N in order to clearly describe the implementation.

FIG. 2A shows the various registers employed in the implementation of the multiple-precision multiply-and-add operation. It should be noted that, in the following discussion, operands and result vectors are described as being contained in registers, although equivalent implementations may employ operands and result vectors stored in memory or in various combinations of memory and registers. Four registers, referred to as y[0], y[1], y[2], and y[3] 202-205 together constitute a four-natural-word operand y. Four registers, referred to as x[0], x[1], x[2], and x[3] 206-209 together constitute an x operand. Two single-natural-word registers tmp 210 and carry 212 store intermediate values, as do the block of registers 214 referred to as t, with each register in the block of registers referred to using a two-dimensional matrix-like notation, such as the notation “t[0][0]” that refers to the first register 216 in the block of registers t 214. It should be noted that the block of registers t 214 is not compact, but instead includes a number of unused registers, due to the offset of rows of intermediate, computed results. The entire block is used, in the implementation below, for notational convenience and clarity of illustration. An eight-natural-word set of registers a[0]-a[7] 218-225 together constitute the vector addend operand a. Finally, nine natural-word registers res[0]-res[8] 225-234 together constitute a result vector “res” which, after completion of the multiply-and-add operation, contains the product of operands x and y added to operand a.

A simple C++-like pseudo-code representation of the first, straightforward implementation of the multiple-precision multiply-and-add operation is next provided. First, a constant MAX_REG is defined to represent the largest numerical value that can be stored in a natural unit of computation, for illustrative purposes, a single byte. A type definition for the type “reg,” representing a register, is also provided.
const unsigned int MAX_REG=256;
typedef unsigned char reg;

Next, a series of in-line routines that represent computer instructions are provided:

```
void multiplyLow (reg & res, const reg x, const reg y)
    {res = (x * y) % MAX_REG;};
void multiplyHigh (reg & res, const reg x, const reg y)
    {res = (x * y) / MAX_REG;};
bool add (reg & res, const reg x, const reg y)
    {res = x + y; return (x + y > MAX_REG);};
bool addPlus (reg & res, const reg x, const reg y)
    {res = x + y + 1; return (x + y + 1 > MAX_REG);};
void inc (reg & res)
    {res = res + 1;};
void mov (reg & res, const reg op)
    {res = op;};
void multiplyAddLow (reg & res, const reg x, const reg y, const reg a)
    {res = ((x * y) + a) % MAX_REG;};
void multiplyAddHigh (reg & res, const reg x, const reg y, const reg a)
    {res = ((x * y) + a) / MAX_REG;};
```

These computer instructions, include: (1) double precision multiply instructions “multiplyLow” and “multiplyHigh,” which compute least significant and most significant result words produced by multiplying two natural-word-sized registers x and y; (2) “add,” “add Plus,” and “inc” instructions that add the contents of two registers, add the contents of two registers and further add one to the result, and increment the contents of a register, respectively; (3) “mov,” which moves the contents of one register to another; and (4) double precision instructions “multiplyAddLow” and “multiplyAddHigh,” which operate similar to the double precision multiply instructions, described above, but that, in addition, add the contents of an addend operand to the product.

Next, a number of variables used in the following implementations are provided. Note that variables corresponding to the registers described above, with reference to FIG. 2A, are given the same names in the pseudo-code, and a few additional variables are included, to be described below:

| | |
|---|---|
| 1 | bool carry; |
| 2 | int carryAcc; |
| 3 | reg a[8]; |
| 4 | reg res[9]; |
| 5 | reg resC[8]; |
| 6 | reg x[4]; |
| 7 | reg y[4]; |
| 8 | reg t[4][9]; |
| 9 | reg tmp; |
| 10 | reg tmp1; |
| 11 | reg tmp2; |
| 12 | reg tmp3; |
| 13 | reg tmp4; |
| 14 | int i, j; |

Next, a pseudo-code implementation of the obvious approach to implementing a multiple-precision multiply-and-add operation is provided:

| | |
|---|---|
| 1 | multiplyLow(t[0][0], x[0], y[0]); |
| 2 | multiplyHigh(tmp, x[0], y[0]); |
| 3 | multiplyLow(t[0][1], x[0], y[1]); |
| 4 | carry = add(t[0][1], tmp, t[0][1]); |
| 5 | multiplyHigh(tmp, x[0], y[1]); |
| 6 | multiplyLow(t[0][2], x[0], y[2]); |
| 7 | if (carry) carry = addPlus(t[0][2], tmp, t[0][2]); |
| 8 | else carry = add(t[0][2], tmp, t[0][2]); |
| 9 | multiplyHigh(tmp, x[0], y[2]); |
| 10 | multiplyLow(t[0][3], x[0], y[3]); |
| 11 | if (carry) carry = addPlus(t[0][3], tmp, t[0][3]); |
| 12 | else carry = add(t[0][3], tmp, t[0][3]); |
| 13 | multiplyHigh(t[0][4], x[0], y[3]); |
| 14 | if (carry) add(t[0][4], 1, t[0][4]); |
| 15 | multiplyLow(t[1][1], x[1], y[0]; |
| 16 | multiplyHigh(tmp, x[1], y[0]); |
| 17 | multiplyLow(t[1][2], x[1], y[1]); |
| 18 | carry = add(t[1][2], tmp, t[1][2]); |
| 19 | multiplyHigh(tmp, x[1], y[1]); |
| 20 | multiplyLow(t[1][3], x[1], y[2]); |
| 21 | if (carry) carry = addPlus(t[1][3], tmp, t[1][3]); |
| 22 | else carry = add(t([1][3], tmp, t[1][3]); |
| 23 | multiplyHigh(tmp, x[1], y[2]); |
| 24 | multiplyLow(t[1][4], x[1], y[3]); |
| 25 | if (carry) carry = addPlus(t[1][4], tmp, t[1][4]); |
| 26 | else carry = add(t[1][4], tmp, t[1][4]); |
| 27 | multiplyHigh(t[1][5], x[1], y[3]); |
| 28 | if (carry) add(t[1][5], 1, t[1][5]); |
| 29 | multiplyLow(t[2][2], x[2], y[0]); |
| 30 | multiplyHigh(tmp, x[2], y[0]); |
| 31 | multiplyLow(t[2][3], x[2], y[1]); |
| 32 | carry = add(t[2][3], tmp, t[2][3]); |
| 33 | multiplyHigh(tmp, x[2], y[1]); |
| 34 | multiplyLow(t[2][4], x[2], y[2]); |
| 35 | if (carry) carry = addPlus(t[2][4], tmp, t[2][4]); |
| 36 | else carry = add(t[2][4], tmp, t[2][4]); |
| 37 | multiplyHigh(tmp, x[2], y[2]); |
| 38 | multiplyLow(t[2][5], x[2], y[3]); |
| 39 | if (carry) carry = addPlus(t[2][5], tmp, t[2][5]); |
| 40 | else carry = add(t[2][5], tmp, t[2][5]); |
| 41 | multiplyHigh(t[2][6], x[2], y[3]); |
| 42 | if (carry) add(t[2][6], 1, t[2][6]); |
| 43 | multiplyLow(t[3][3], x[3], y[0]); |
| 44 | multiplyHigh(tmp, x[3], y[0]); |
| 45 | multiplyLow(t[3][4], x[3], y[1]); |
| 46 | carry = add(t[3][4], tmp, t[3][4]); |
| 47 | multiplyHigh(tmp, x[3], y[1]); |
| 48 | multiplyLow(t[3][5], x[3], y[2]); |
| 49 | if (carry) carry = addPlus(t[3][5], tmp, t[3][5]); |
| 50 | else carry = add(t[3][5], tmp, t[3][5]); |
| 51 | multiplyHigh(tmp, x[3], y[2]); |
| 52 | multiplyLow(t[3][6], x[3], y[3]); |
| 53 | if (carry) carry = addPlus(t[3][6], tmp, t[3][6]); |
| 54 | else carry = add(t[3][6], tmp, t[3][6]); |
| 55 | multiplyHigh(t[3][7], x[3], y[3]); |
| 56 | if (carry) add(t[3][7], 1, t[3][7]); |
| 57 | mov(res[0], t[0][0]); |
| 58 | carryAcc = 0; |
| 59 | for(i = 1; i < 8; i++) |
| 60 | { |
| 61 | add(res[i], t[0][i], carryAcc); |
| 62 | carryAcc = 0; |
| 63 | for (j = 1; j < 4; j++) |
| 64 | { |
| 65 | if (add(res[i], res[i], t[j][i])) carryAcc++; |
| 66 | } |
| 67 | } |
| 68 | carry = false; |
| 69 | for (i = 0; i < 8; i++) |
| 70 | { |
| 71 | if (carry) carry = addPlus(res[i], a[i], res[i]); |
| 72 | else carry = add(res[i], a[i], res[i]); |
| 73 | } |
| 74 | if (carry) mov(res[8], 1); |

The above implementation uses the in-line-routine representations of the various computer instructions to implement the multiply-and-add operation, along with some more traditional C-like or C++-like control structures to succinctly present portions of the implementation that would otherwise require more complex, although straightforward, implementations in machine instructions. The above implementation is described with reference to FIGS. 2B-N. The implementation carries out a multiple-precision multiply-and-add operation very much like traditional, longhand-multiply and longhand-add operations are carried about by elementary school students. In the first two instructions, on lines 1-2 above, the first natural word of operand x, x[0] 206, and the first natural word of operand y, y[0] 202, are multiplied together, with the least significant natural word of the result placed into register t[0][0] 216 and the most significant natural word of the product placed into the register tmp 210. Next, as shown in FIG. 2C, the first natural word of operand x, x[0] 206, and the second natural word of operand y, y[1] 203, are multiplied together, with the least significant natural word of the product moved to register t[0][1] 228. This operation is carried out by the instruction on line 3 in the pseudo-code routine, above. Then, on line 4 of the pseudo-code routine, and as shown in FIG. 2D, the contents of the register tmp 210 are added to the contents of register t[0][1]. Finally, as shown on line 5 of the above pseudo-code routine, and in FIG. 2E, the most significant natural word of the product of x[0] and y[1] is placed into register tmp 210. Note that the above steps are similar to the first steps of long hand multiplication. The process continues with the multiplication of register x[0] and register y[2], with the least significant natural word of the product placed into register 230, as shown in FIG. 2F and on line 6 of the above pseudo-code. The process further continues until register x[0] multiplies each of the natural words in operand y by the instructions on lines 1-14 in the above pseudo-code routine. The result of the execution of these first 14 instructions is shown in FIG. 2G.

In the next block of instructions on lines 15-28 in the above pseudo-code implementation, the register x[1] multiplies each of the natural-word registers in operand y to produce a second row 232 of intermediate results, as shown in FIG. 2H. Similarly, as shown in FIG. 2I, the next block of instructions on lines 29-42 carry out multiplication of all of the natural-word registers of operand y by register x[2]. Finally, the block of instructions represented by lines 43-56 of the above pseudo-code routine result in production of a fourth row 234 of intermediate results, as shown in FIG. 2J.

Next, in the nested for-loops of lines 57-67, the columns within the two-dimensional-matrix-like block of registers t are added together. In FIG. 2K, since the first column of the block of registers t has only a single entry, the first column of the block of registers t is added together by moving the contents of register t[0][0] 216 to register res[0] 226. The next column of register block t is added together by adding the contents of register t[0][1] 228 with the contents of register t[1][1] 236 to produce the value “7C” placed into register res[1] 227 as well as a carry bit, stored in a carry-bit accumulator “carryACC.” Following execution of the nested for-loops on lines 57-67, the product of operands x and y resides in the first eight natural words of the result vector res, as shown in FIG. 2L.

Finally, in the block on instructions 68-74 in the above pseudo-code implementation, the contents of operand a are added to the result vector res, as shown in FIG. 2M, to produce the final result, shown in FIG. 2N.

This first, straight-forward implementation of a multiple-precision multiply-and-add operation produces the correct result, but is not amenable to instruction-execution parallelism, and is reasonable inefficient. Note, for example, that the first double precision multiplication on lines 1-2 produce a result stored in register tmp, which is then used in the fourth instruction, in which the contents of register tmp are added to the contents of register t[0][1]. Thus, the instructions on line 4 must wait until completion of the instructions in lines 1-3. Moreover, the fifth instruction again writes a result to register tmp, and therefore must execute after the prior contents of register tmp are used in the above add instruction on line 4. Such write dependencies occur throughout the above implementation of the multiple-precision multiply-and-add operation, greatly limiting the degree to which parallel execution of instructions, provided by a modern processor, can be used to increase the performance of the implementation.

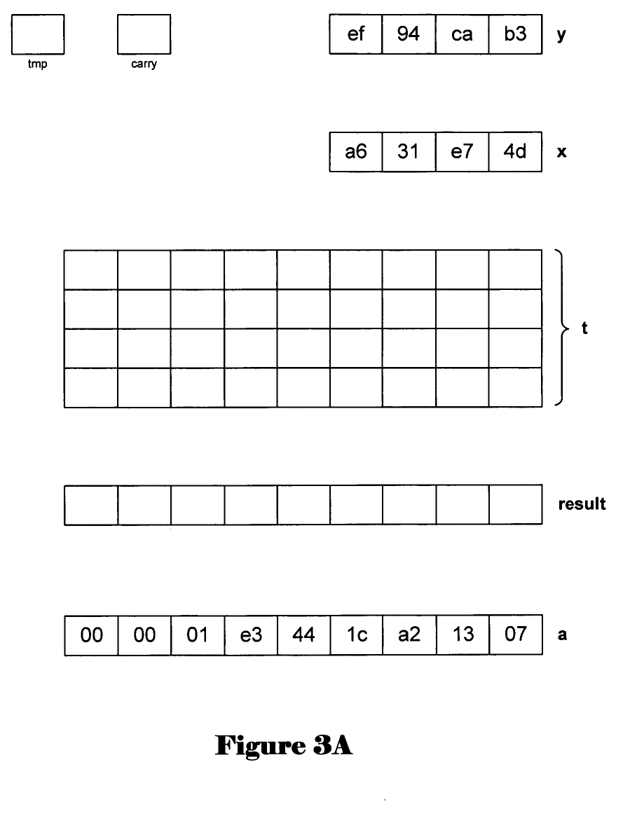

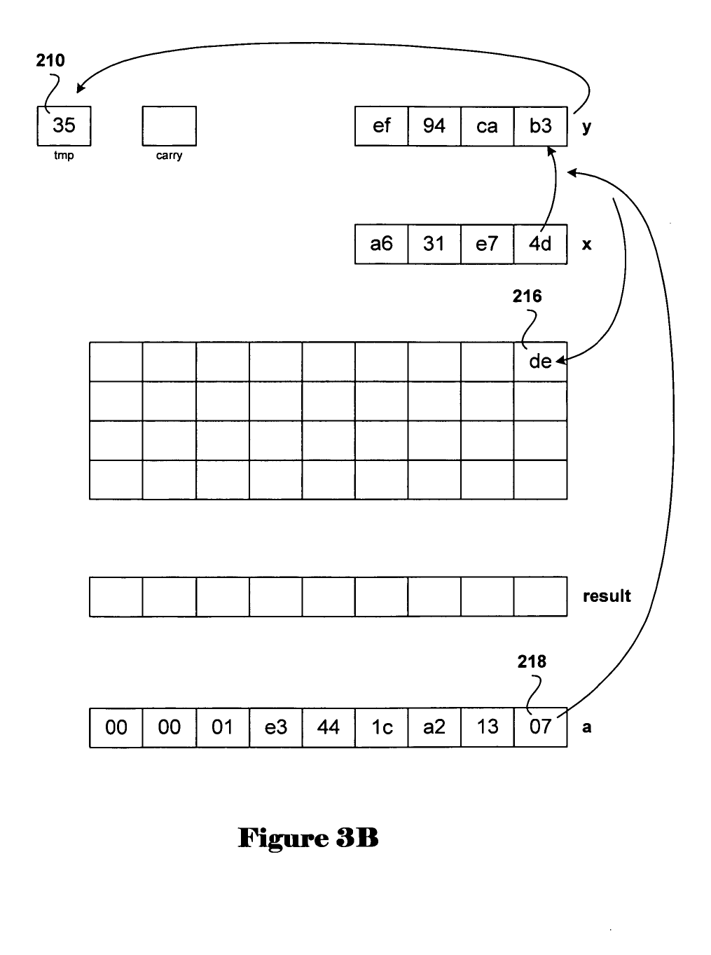

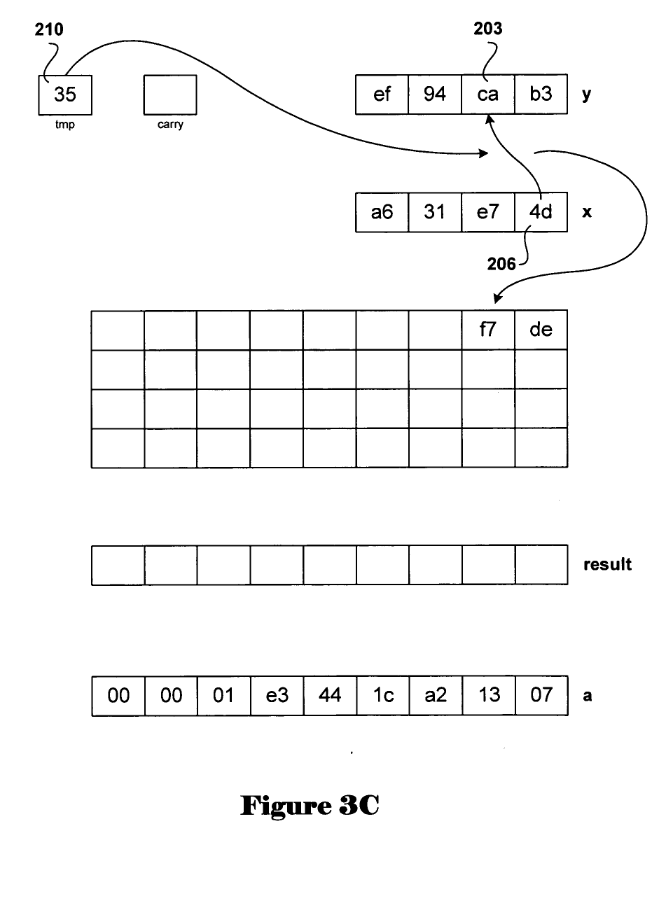

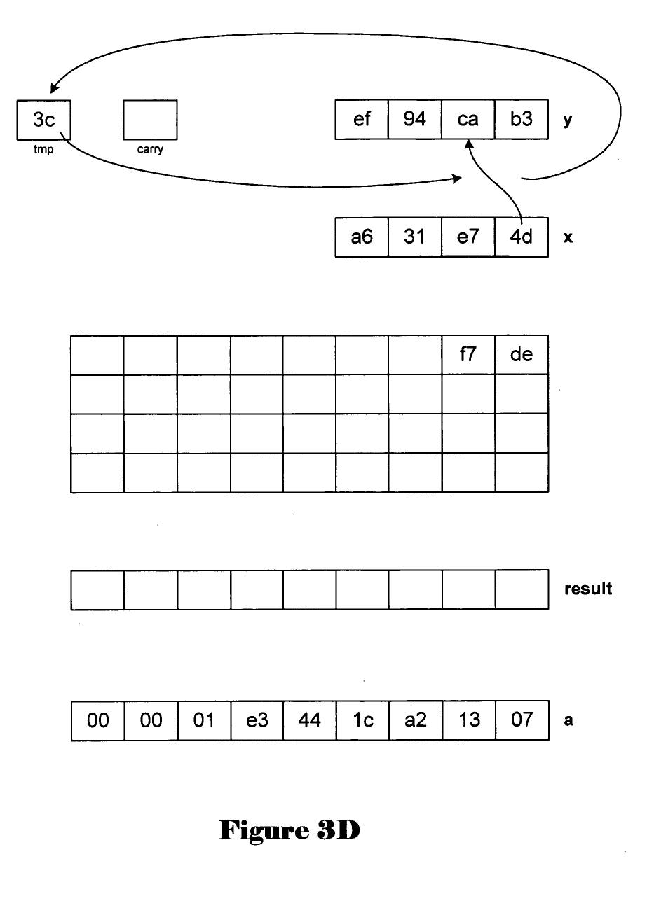

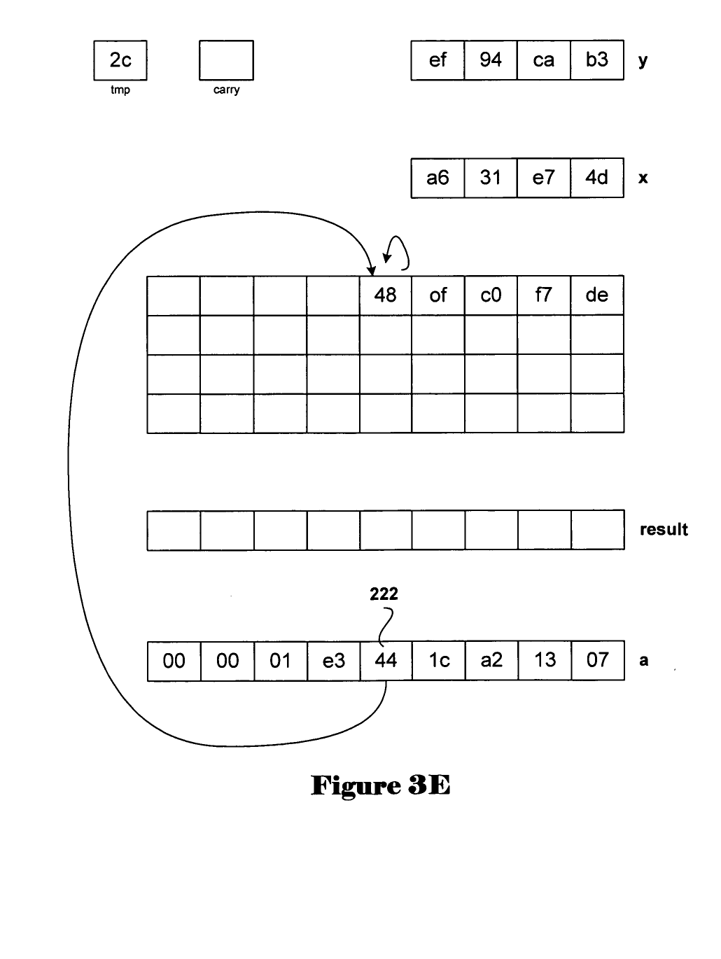

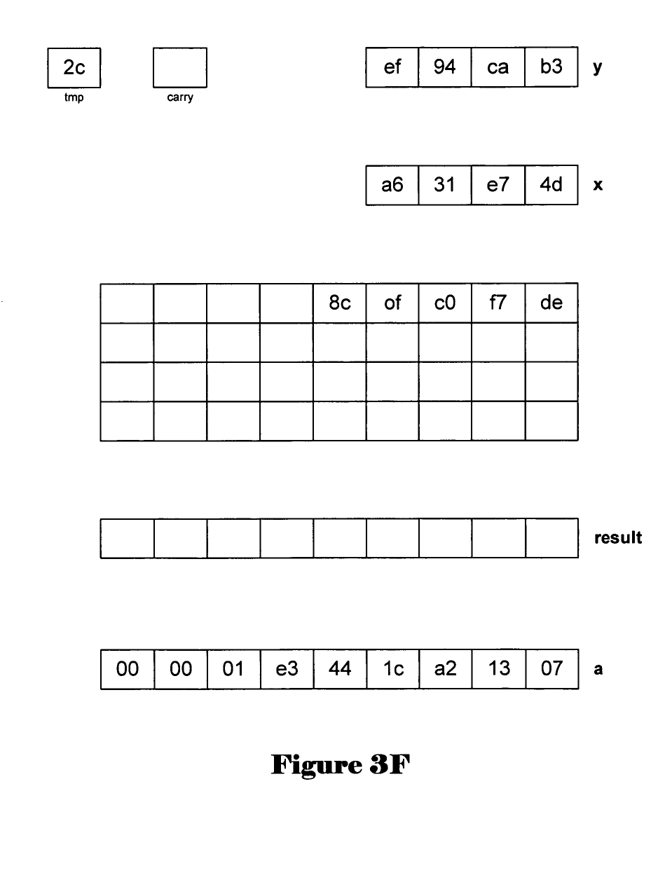

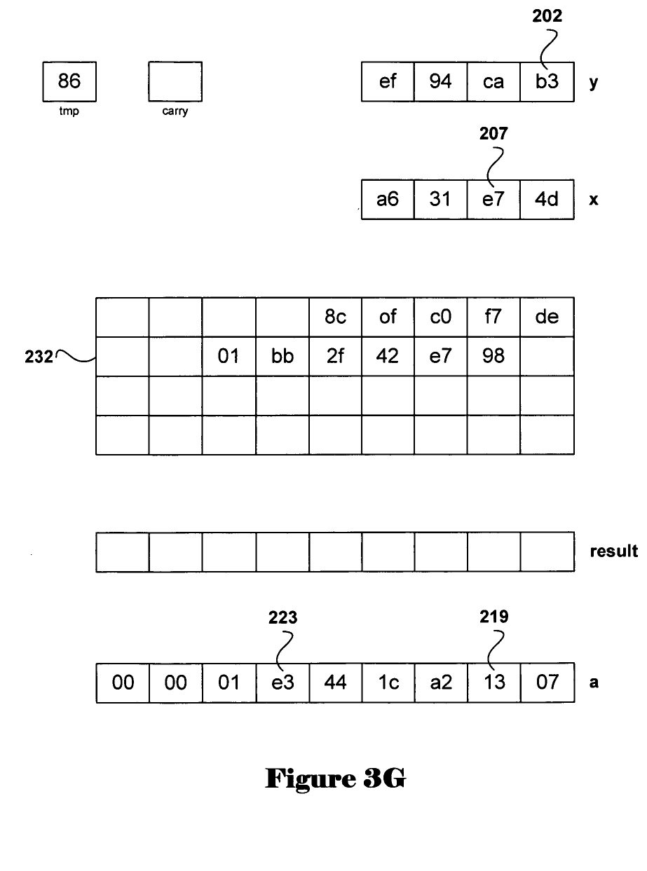

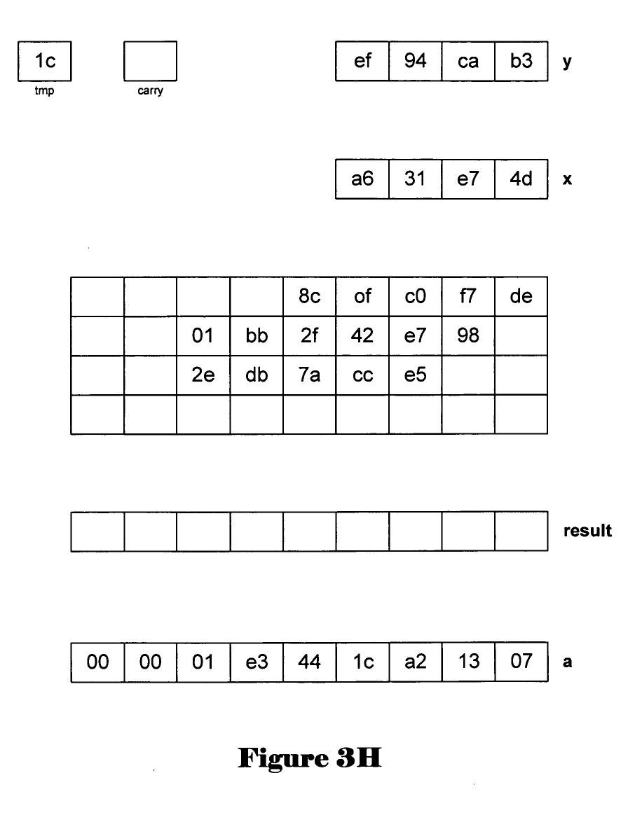

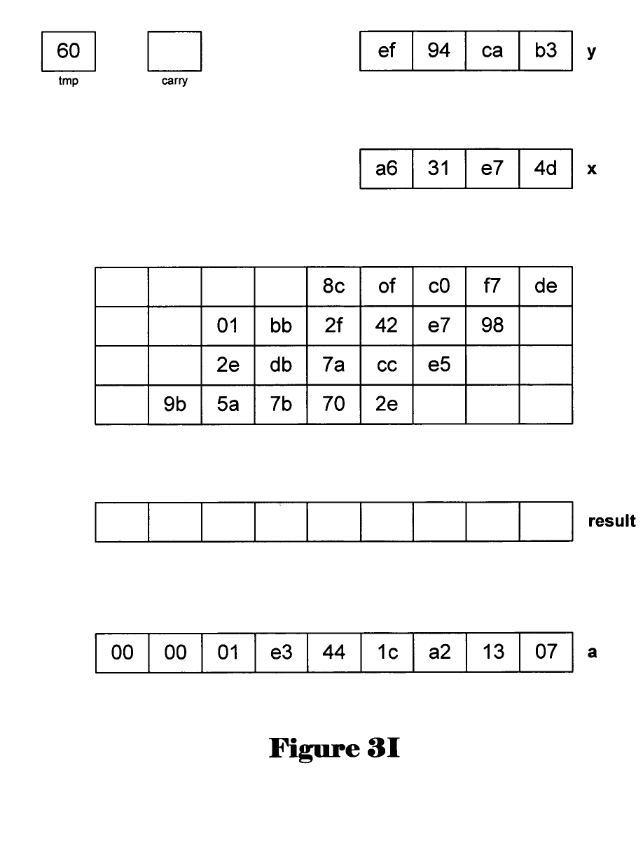

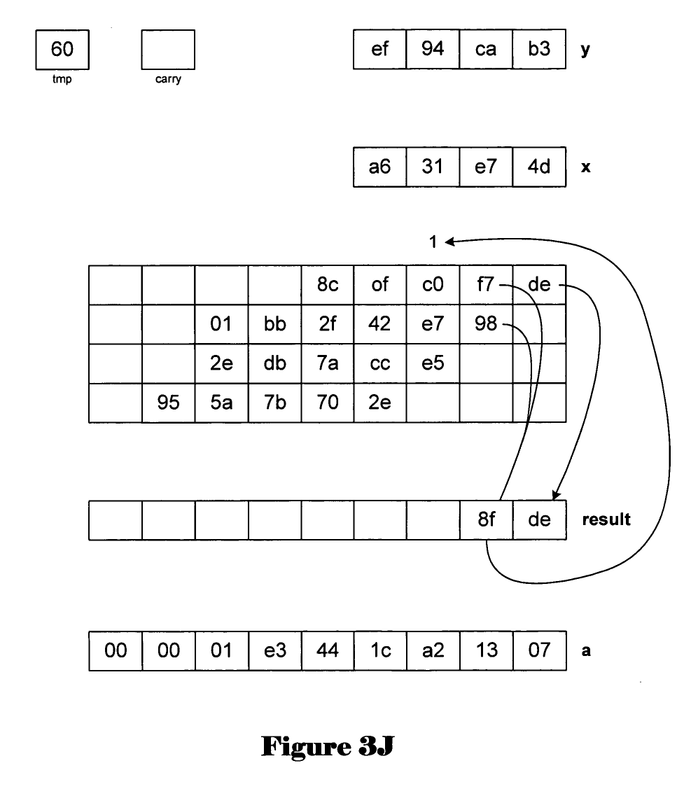

FIGS. 3A-J illustrate an implementation of a multiple-precision multiply-and-add that is more computationally efficient that the implementation illustrated in FIGS. 2A-N. Greater efficiency is obtained in the second implementation by making use of double-precision multiply-and-add instructions provided by a number of modem processors, including the Intel Itanium® processor.

| | |
|---|---|
| 1 | multiplyAddLow(t[0][0], x[0], y[0], a[0]); |
| 2 | multiplyAddHigh(tmp, x[0], y[0], a[0]); |
| 3 | multiplyAddLow(t[0][1], x[0], y[1], tmp); |
| 4 | multiplyAddHigh(tmp, x[0], y[1], tmp); |
| 5 | multiplyAddLow(t[0][2], x[0], y[2], tmp); |
| 6 | multiplyAddHigh(tmp, x[0], y[2], tmp); |
| 7 | multiplyAddLow(t[0][3], x[0], y[3], tmp); |
| 8 | multiplyAddHigh(t[0][4], x[0], y[3], tmp); |
| 9 | if (add(t[0][4], t[0][4], a[4])) mov(t[0][5], 1); |
| 10 | multiplyAddLow(t[1][1], x[1], y[0], a[1]); |
| 11 | multiplyAddHigh(tmp, x[1], y[0], a[1]); |
| 12 | multiplyAddLow(t[1][2], x[1], y[1], tmp); |
| 13 | multiplyAddHigh(tmp, x[1], y[1], tmp); |
| 14 | multiplyAddLow(t[1][3], x[1], y[2], tmp); |
| 15 | multiplyAddHigh(tmp, x[1], y[2], tmp); |
| 16 | multiplyAddLow(t[1][4], x[1], y[3], tmp); |
| 17 | multiplyAddHigh(t[1][5], x[1], y[3], tmp); |
| 18 | if (add(t[1][5], t[1][5], a[5])) mov(t[1][6], 1); |
| 19 | multiplyAddLow(t[2][2], x[2], y[0], a[2]); |
| 20 | multiplyAddHigh(tmp, x[2], y[0], a[2]); |
| 21 | multiplyAddLow(t[2][3], x[2], y[1], tmp); |
| 22 | multiplyAddHigh(tmp, x[2], y[1], tmp); |
| 23 | multiplyAddLow(t[2][4], x[2], y[2], tmp); |
| 24 | multiplyAddHigh(tmp, x[2], y[2], tmp); |
| 25 | multiplyAddLow(t[2][5], x[2], y[3], tmp); |
| 26 | multiplyAddHigh(t[2][6], x[2], y[3], tmp); |
| 27 | if (add(t[2][6], t[2][6], a[6])) mov(t[2][7], 1); |
| 28 | multiplyAddLow(t[3][3], x[3], y[0], a[3]); |
| 29 | multiplyAddHigh(tmp, x[3], y[0], a[3]); |
| 30 | multiplyAddLow(t[3][4], x[3], y[1], tmp); |
| 31 | multiplyAddHigh(tmp, x[3], y[1], tmp); |
| 32 | multiplyAddLow(t[3][5], x[3], y[2], tmp); |
| 33 | multiplyAddHigh(tmp, x[3], y[2], tmp); |
| 34 | multiplyAddLow(t[3][6], x[3], y[3], tmp); |
| 35 | multiplyAddHigh(t[3][7], x[3], y[3], tmp); |
| 36 | if (add(t[3][7], t[3][7], a[7])) mov(t[3][8], 1); |
| 37 | mov(res[0], t[0][0]); |
| 38 | carryAcc = 0; |
| 39 | for (i = 1; i < 8; i++) |
| 40 | { |
| 41 | add(res[i], t[0][i], carryAcc); |
| 42 | carryAcc = 0; |
| 43 | for (j = 1; j < 4; j++) |
| 44 | { |
| 45 | if (add(res[i], res[i], t[j][i])) carryAcc++; |
| 46 | } |
| 47 | } |

Comparison of the second implementation with the first implementation reveals that the second implementation, by using the double-precision multiply-and-add machine instructions, can be much more simply and concisely coded. The approach is, nonetheless, similar to the approach of the first implementation, and is reminiscent of longhand multiplication and addition methods. FIG. 3A shows, in the manner of FIGS. 2A-N, the starting point for carrying out the example multiple-precision multiply-and-add operation discussed with reference to FIGS. 1A-C by the method of the second implementation. On lines 1-2 of the second implementation, above, a double-precision multiply-and-add operation is carried out on the first natural word of the x operand, x[0], and the first natural word of the y operand, y[0]. This multiply-and-add operation is illustrated in FIG. 3B. The least significant natural word of the product of the operation is placed into register t[0][0] 216 and the most significant natural word of the product is placed into the register tmp 210. Note, however, that unlike in the first instructions of the first implementation, illustrated in FIG. 2B, the first two instructions of the second implementation not only multiply the first natural words of the x and y operands, but also add to the product of that multiplication the first natural word of the operand a, a[0] 218. The next two instructions, on lines 3-4, carry out a multiply-and-add operation using the first natural word of the x operand, x[0] 206, the second natural word of the y operand, y[1] 203, and the contents of register tmp 210, as shown in FIGS. 3C-D. Thus, in the second implementation, the multiply-and-add instructions continue to add in the contents of the register tmp as results for a first row of intermediate results are computed. Following computation of the first row of intermediate results, the contents of the fifth natural word of the operand a, a[4] 222 are added to the contents of register t[0][4], in the add instruction of line 9, as shown in FIG. 3E. FIG. 3F shows the result following execution of the instructions in the first block of instructions in the second implementation, on lines 1-9.

The method of the second implementation proceeds, in the next block of instructions on lines 10-18, to compute a second row 232 of intermediate results, as shown in FIG. 3G. In computation of the second row of intermediate results 232, the contents of the second natural word of operand a, a[1] 219 are added to the product of the second natural word of the x operand, x[1] 207 and the contents of the sixth natural word of the operand a, a[5] 223 are added to the contents of register t[1][5]. The next block of instructions, on lines 19-27, above, compute a third intermediate result row, as shown in FIG. 3H, and the following block of instructions on lines 28-36, above, compute a fourth row of intermediate results, as shown in FIG. 3I. In the nested for-loops of lines 37-47, as shown in FIG. 3J, the columns of the two-dimensional register matrix t are added, just as in the nested for-loops of lines 57-67 of the first implementation. This produces a final result, as shown in FIG. 2N, above, with respect to the first implementation.

The second implementation is more efficient than the first implementation, containing significantly less instructions that the first implementation. Moreover, rather than including for-loop blocks to carry out two separate vector additions, as in the first implementation, only a single, final for-loop block is needed in the second implementation to add the columns of the two-dimensional matrix-like register block t. However, the second implementation is replete with write dependencies, just as the first implementation. For example, the first multiply-and-add operation, on lines 1-2, places a result in the register tmp. That result is immediately used in the second multiply-and-add operation on lines 3-4. Thus, the first two instructions of the second implementation must complete before the second two instructions can begin.

One embodiment of the present invention is motivated by a recognition that the ordering of operations within the straight-forward implementations, such as the first and second implementations, described above, can be significantly modified to order to partition write dependencies within the implement provide for much greater, potential parallel execution of instructions.

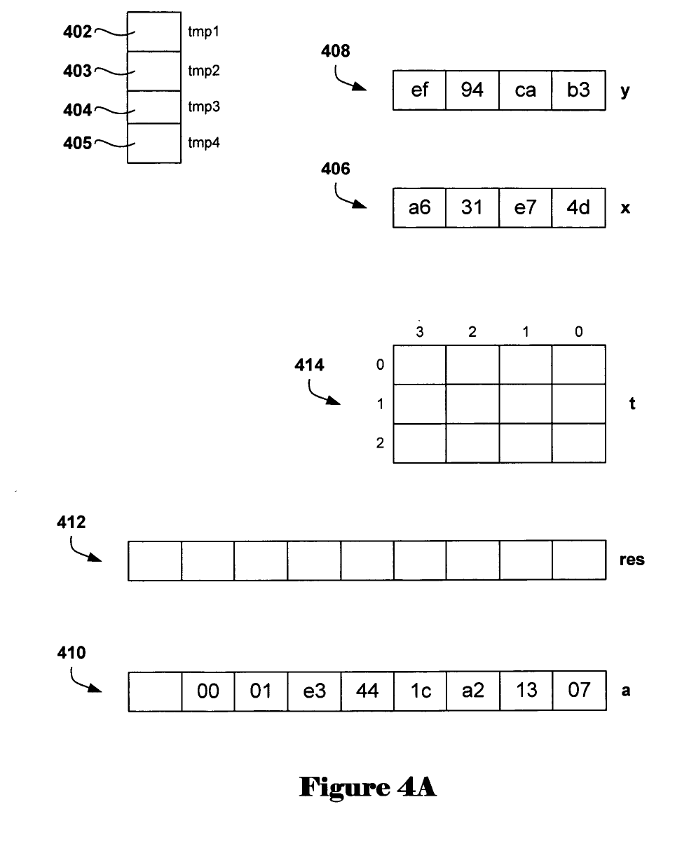

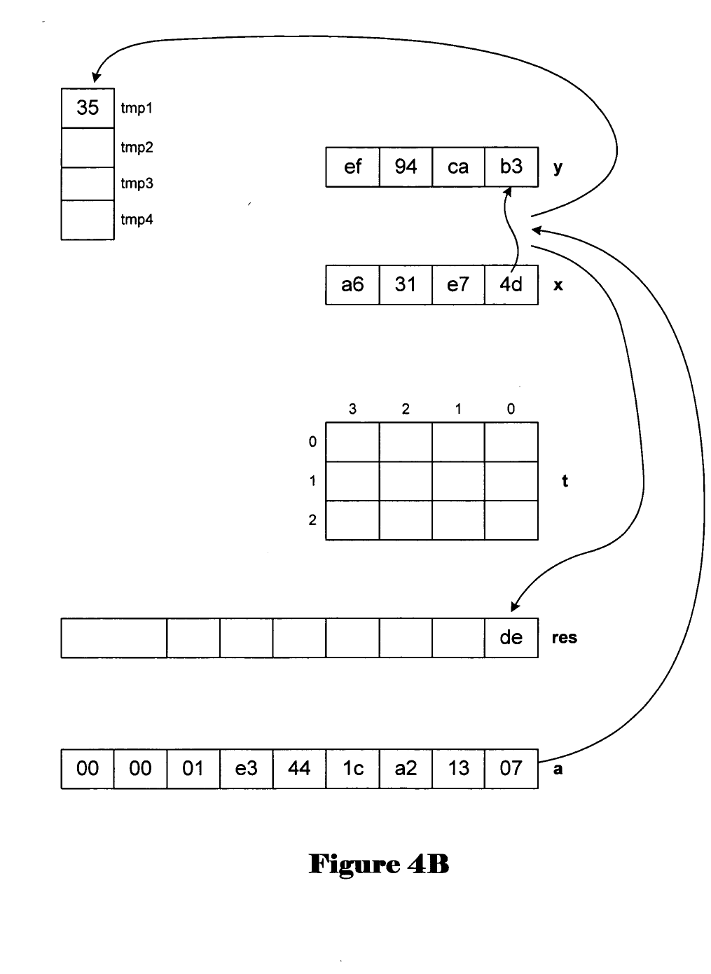

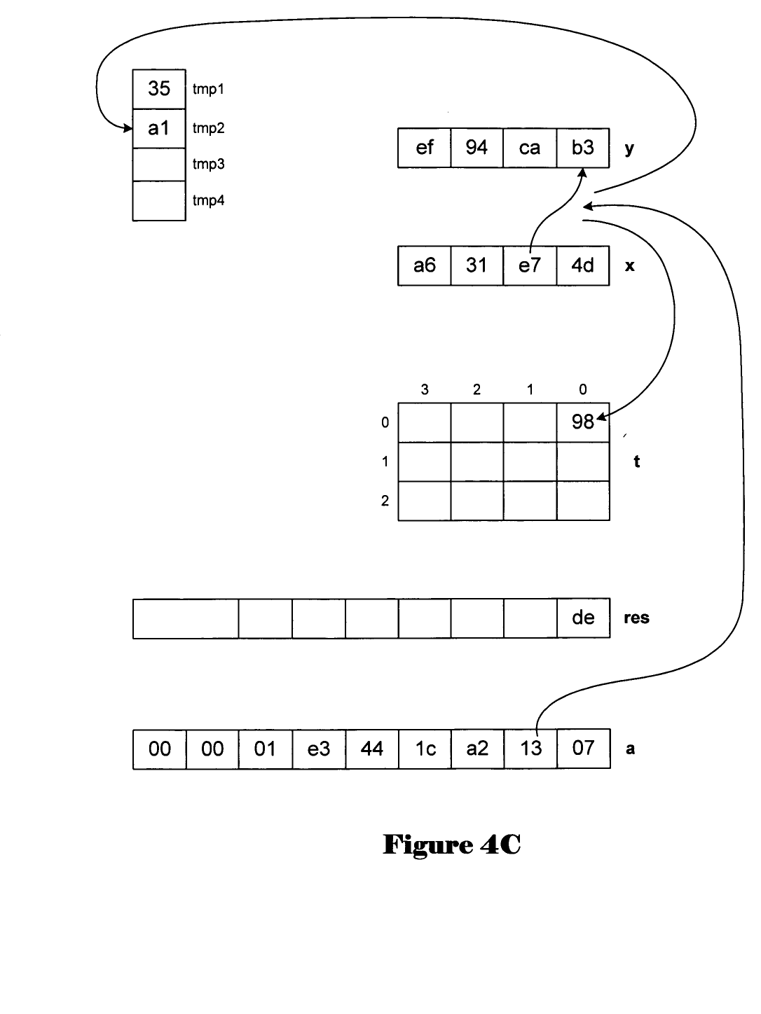

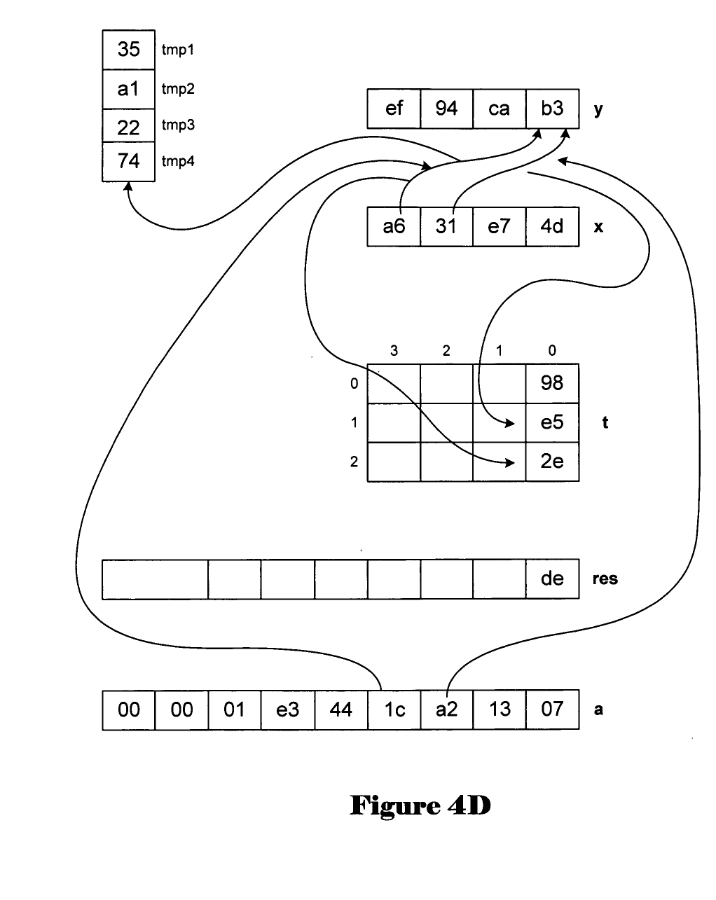

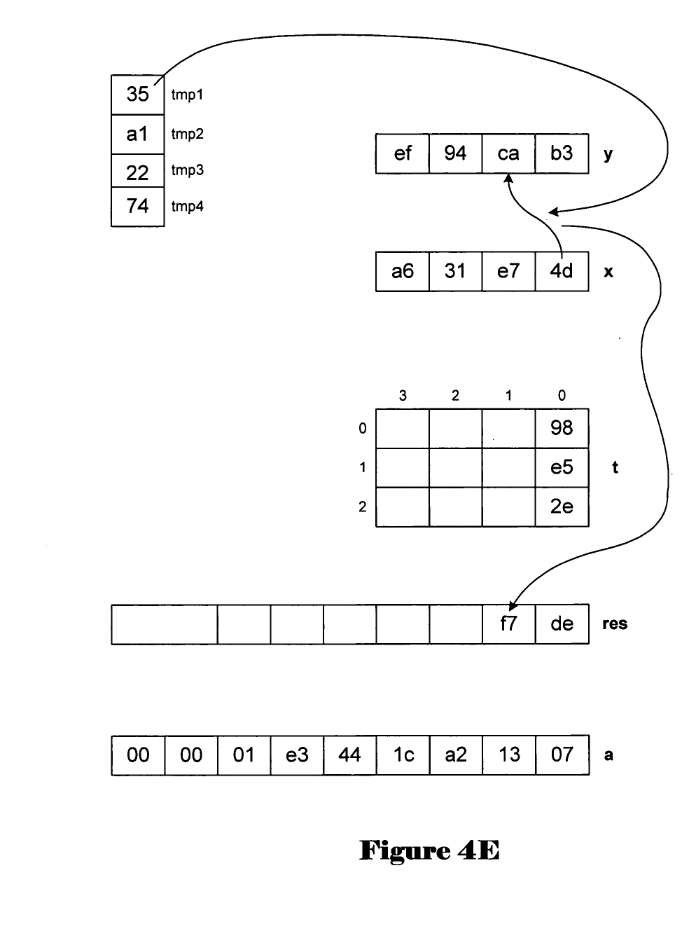

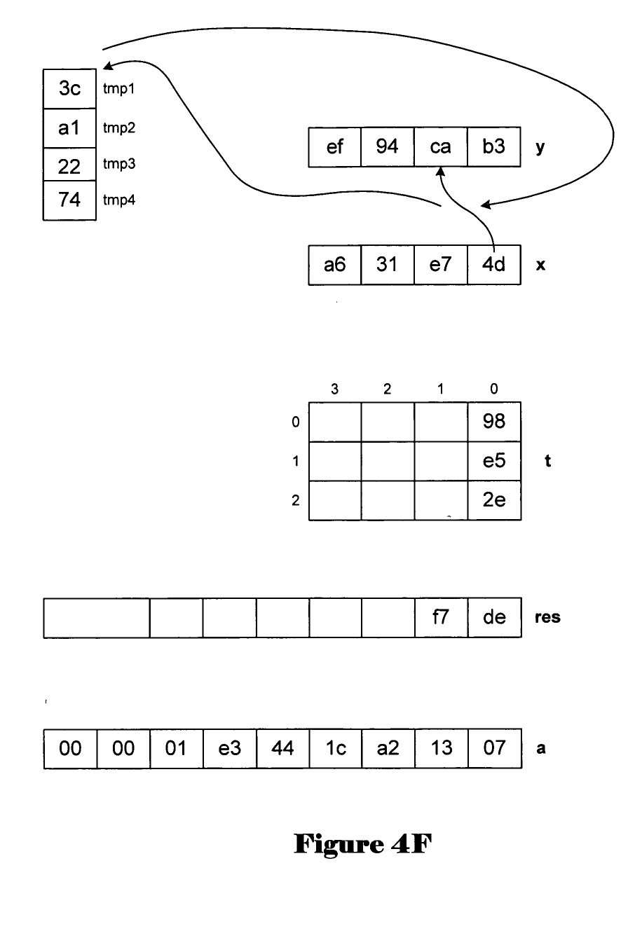

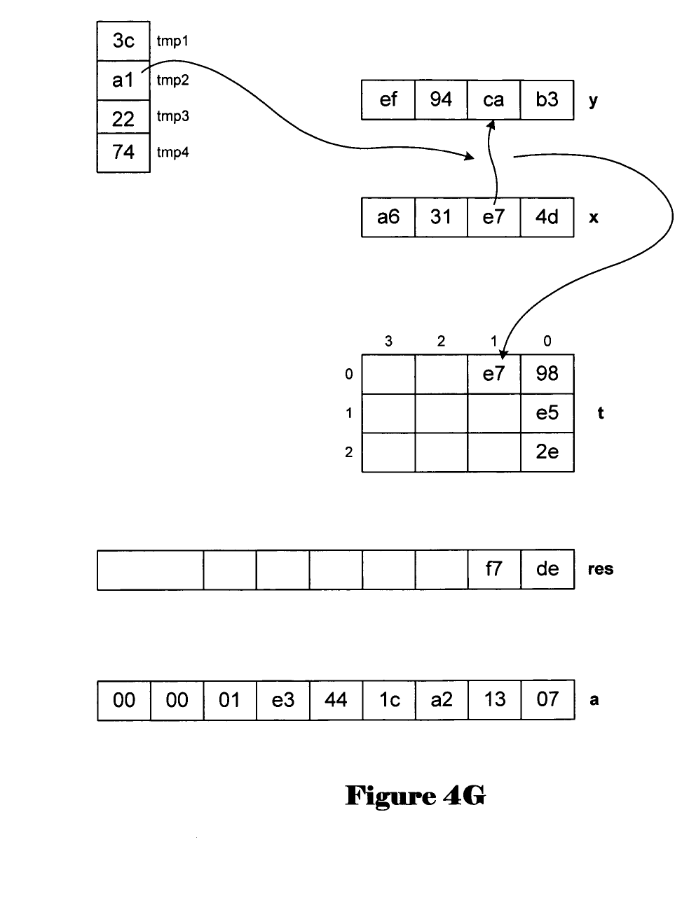

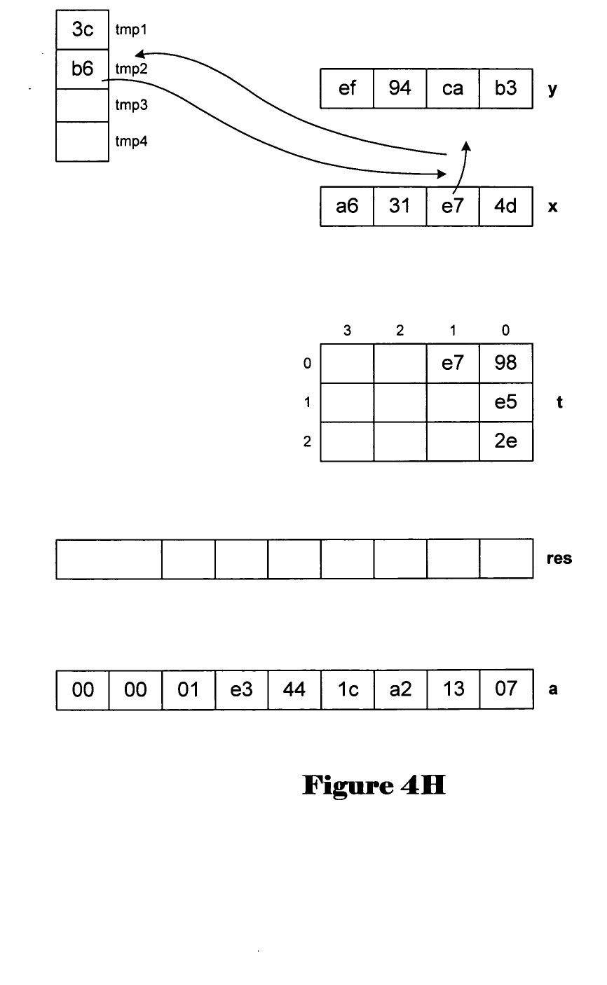

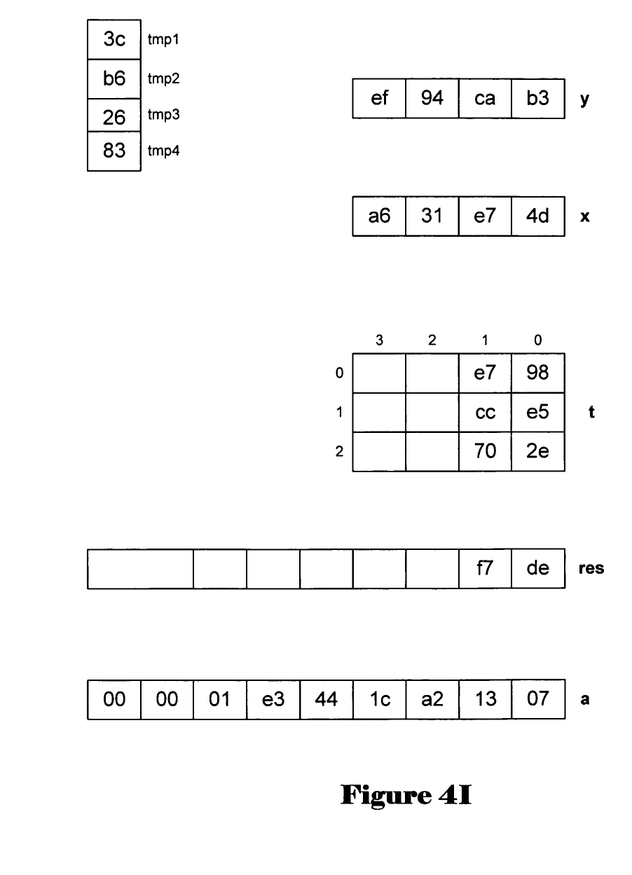

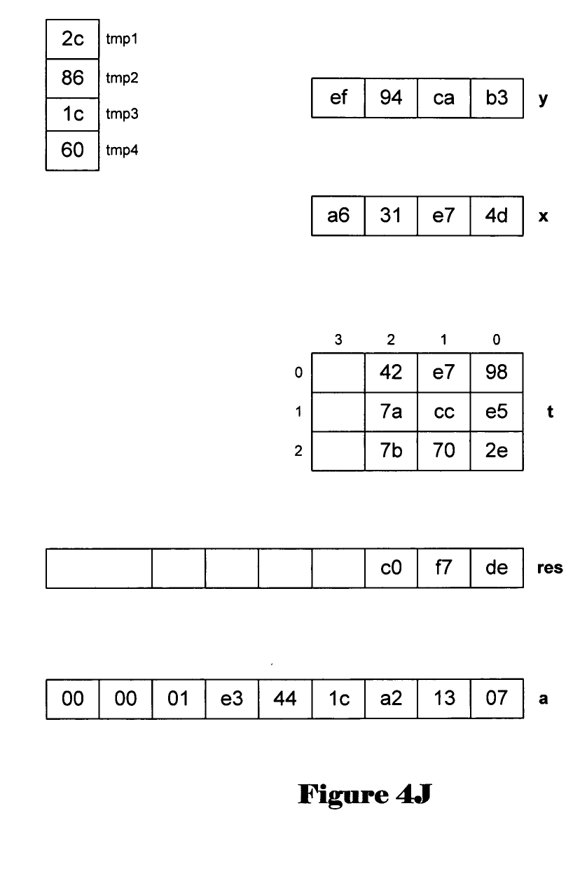

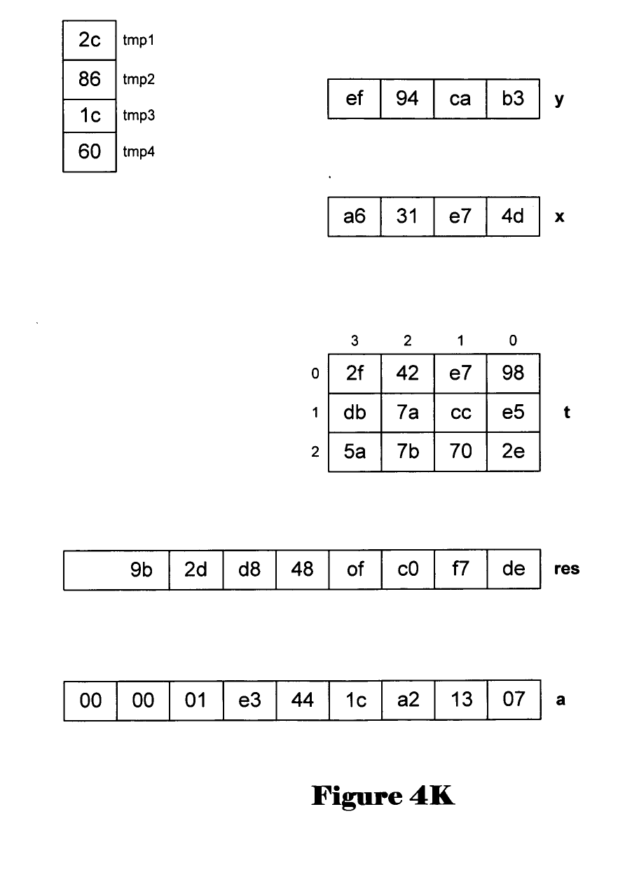

FIGS. 4A-K illustrate execution of an embodiment of a multiple-precision multiply-and-add operation. A pseudocode representation of this implementation is provided below:

| | |
|---|---|
| 1 | multiplyAddLow(res[0], x[0], y[0], a[0]); |
| 2 | multiplyAddHigh(tmp1, x[0], y[0], a[0]); |
| 3 | multiplyAddLow(t[0][0], x[1], y[0], a[1]); |
| 4 | multiplyAddHigh(tmp2, x[1], y[0], a[1]); |
| 5 | multiplyAddLow(t[1][0], x[2], y[0], a[2]); |
| 6 | multiplyAddHigh(tmp3, x[2], y[0], a[2]); |
| 7 | multiplyAddLow(t[2][0], x[3], y[0], a[3]); |
| 8 | multiplyAddHigh(tmp4, x[3], y[0], a[3]); |
| 9 | multiplyAddLow(res[1], x[0], y[1], tmp1); |
| 10 | multiplyAddHigh(tmp1, x[0], y[1], tmp1); |
| 11 | multiplyAddLow(t[0][1], x[1], y[1], tmp2); |
| 12 | multiplyAddHigh(tmp2, x[1], y[1], tmp2); |
| 13 | multiplyAddLow(t[1][1], x[2], y[1], tmp3); |
| 14 | multiplyAddHigh(tmp3, x[2], y[1], tmp3); |
| 15 | multiplyAddLow(t[2][1], x[3], y[1], tmp4); |
| 16 | multiplyAddHigh(tmp4, x[3], y[1], tmp4); |
| 17 | multiplyAddLow(res[2], x[0], y[2], tmp1); |
| 18 | multiplyAddHigh(tmp1, x[0], y[2], tmp1); |
| 19 | multiplyAddLow(t[0][2], x[1], y[2], tmp2); |
| 20 | multiplyAddHigh(tmp2, x[1], y[2], tmp2); |
| 21 | multiplyAddLow(t[1][2], x[2], y[2], tmp3); |
| 22 | multiplyAddHigh(tmp3, x[2], y[2], tmp3); |
| 23 | multiplyAddLow(t[2][2], x[3], y[2], tmp4); |
| 24 | multiplyAddHigh(tmp4, x[3], y[2], tmp4); |
| 25 | multiplyAddLow(res[3], x[0], y[3], tmp1); |
| 26 | multiplyAddHigh(res[4], x[0], y[3], tmp1); |
| 27 | multiplyAddLow(t[0][3], x[1], y[3], tmp2); |
| 28 | multiplyAddHigh(res[5], x[1], y[3], tmp2); |
| 29 | multiplyAddLow(t[1][3], x[2], y[3], tmp3); |
| 30 | multiplyAddHigh(res[6], x[2], y[3], tmp3); |
| 31 | multiplyAddLow(t[2][3], x[3], y[3], tmp4); |
| 32 | multiplyAddHigh(res[7], x[3], y[3], tmp4); |
| 33 | if (add(res[1], t[0][0], res[1])) inc (resC[2]); |
| 34 | if (add(res[2], t[1][0], res[2])) inc (resC[3]); |
| 35 | if (add(res[3], t[0][2], res[3])) inc (resC[4]); |
| 36 | if (add(res[4], t[0][3], res[4])) inc (resC[5]); |
| 37 | if (add(res[5], t[1][3], res[5])) inc (resC[6]); |
| 38 | if (add(res[6], t[2][3], res[6])) inc (resC[7]); |
| 39 | if (add(res[1], res[1], resC[1])) inc (resC[2]); |
| 40 | if (add(res[2], t[0][1], res[2])) inc (resC[3]); |
| 41 | if (add(res[3], t[1][1], res[3])) inc (resC[4]); |
| 42 | if (add(res[4], t[1][2], res[4])) inc (resC[5]); |
| 43 | if (add(res[5], t[2][2], res[5])) inc (resC[6]); |
| 44 | if (add(res[6], res[6], a[6])) inc (resC[7]); |
| 45 | if (add(res[7], res[7], a[7])) inc (resC[8]); |
| 46 | if (add(res[2], res[2], resC[2])) inc (resC[3]); |
| 47 | if (add(res[3], t[2][0], res[3])) inc (resC[4]); |
| 48 | if (add(res[4], t[2][1], res[4])) inc (resC[5]); |
| 49 | if (add(res[5], res[5], a[5])) inc (resC[6]); |
| 50 | if (add(res[4], res[4], a[4])) inc (resC[5]); |
| 51 | if (add(res[3], res[3], resC[3])) inc (resC[4]); |
| 52 | if (add(res[4], res[4], resC[4])) inc (resC[5]); |
| 53 | if (add(res[5], res[5], resC[5])) inc (resC[6]); |
| 54 | if (add(res[6], res[6], resC[6])) inc (resC[7]); |
| 55 | if (add(res[7], res[7], resC[7])) inc (resC[8]); |
| 56 | add(res[8], res[8], resC[8]); |

FIG. 4A illustrates a starting point for the multiply-and-add operation, as discussed above with reference to FIGS. 1A-C, as carried about by the above implementation that represents one embodiment of the present invention. Note that, in FIG. 4A, a somewhat different set of register variables are employed. Four register variables tmp1-tmp4 402-405 are used to store temporary results. As before, four-natural-word register vectors 406 and 408 store the x and y operands, respectively. An eight-natural-word vector of registers store the operand a 410, and a nine-natural-word vector of registers stores the result register vector 412. A two-dimensional matrix-like group or block of registers t 414, also store intermediate results. In the embodiment described with reference to FIGS. 4A-K, the block of registers t 414 is more compact than the block of registers t used in the previously described implementation. When values from the block of registers t 414 are added together, diagonals of values are added to a particular word of the result vector, rather than columns of values, as in the previously described implementations. Also, unlike in the previously described implementations, as discussed below, the values in the addend vector operand a are added along with the pair-wise multiplication of words from the x and y operands, eliminating a separate, final step, as in previously described implementations, in which the addend vector operand a is added to the result vector. Note that the register-name conventions used in discussion of the first implementations are again used in the discussion of the third implementation that represents one embodiment of the present invention.

In the first block of instructions, on lines 1-8, above, double-precision multiply-and-add operations are carried out with respect to all four-natural-word registers of the x operand, x[0]-x[3], the first four-natural-word registers of the a operand, a[0]- a[3], and the first-natural-word register of the y operand, y[0]. The result of execution of the instructions on lines 1-2 are shown in FIG. 4B. The result of the execution of the instructions on lines 3-4 are shown in FIG. 4C, and the result of execution of the remaining instructions in the block of instructions on lines 1-8 are shown in FIG. 4D. Note that, in the implementation representing one embodiment of the present invention, a first natural-word register of the register vector res, res[0], and a column of intermediate results within the register block t, are produced by execution of the first block of instructions, rather than a row within the register block t, as in the first and second implementations. In the next block of instructions, on lines 9-16, a second column of intermediate results in the register block t is computed. In the first two instructions of the second block, on lines 9-10 a second natural-word of the result vector, res[1] is computed, and the value of the register tmp1 is updated, as shown in FIG. 4E-F. Next, in the instructions on lines 11-12, x[1] multiplies y[1], and the contents of register tmp2 are added to the product, with the least significant natural-word of the result placed into register t[0][1] and the most significant natural-word of the result placed into register tmp2, as shown in FIGS. 4G and 4H. Completion of the second block of instruction, on lines 9-16, above, produces a second column of intermediate results in the register block t as shown in FIG. 4I. Execution of the third block of instructions, on lines 17-24, produces a third column of intermediate results in register block t, as shown in FIG. 4J. Finally, in a series of instruction blocks beginning on line 33, the contents of registers in the register block t are added to the registers of the register vector res to produce the final result, shown in FIG. 4K.

Thus, the third implementation representing one embodiment of the present invention features a greatly changed ordering of instructions, and somewhat different instructions, with respect to the straight-forward first and second implementations to produce a markedly more efficient, multiple-precision, multiply-and-add operation. In the above pseudo-code implementation, there are no write dependencies in any of the blocks of instructions. For example, all eight instructions on lines 1-8 may be executed in parallel, should parallel execution of eight multiply-and-add instructions be supported on a particular machine. Similarly, all eight instructions in the second block of instructions, on lines 9-16, may be executed in parallel. In a massively parallel architecture, the multiple-precision multiply-and-add operation that represents one embodiment of the present invention may be theoretically executed in a number of machine cycles equal to:
machine cycles=(4×ma)+(9×a)
where ma is the number of machine cycles needed to execute a multiply-and-add instruction, and
a is the number of machine cycles needed to execute an add instruction. There are many different possible groupings of the instructions of the above embodiment, each of which features blocks of instructions without write dependencies and therefore executable in parallel. For example, certain of the latter add instructions can be alternatively placed into previous blocks containing multiply-and-add instructions. There are many different highly parallelizable instruction orderings.

Although the present invention has been described in terms of a particular embodiment, it is not intended that the invention be limited to this embodiment. Modifications within the spirit of the invention will be apparent to those skilled in the art. For example, multiple-precision multiply-and-add operations involving operands of any length may be implemented using the techniques described above with respect to the third implementation, in which the x, y, and a operands include four, four, and eight natural-word-sized elements. As discussed above, the present invention may be used to design multiple-precision multiply-and-add operations for various different computer architectures that feature various different natural word sizes. For example, the present invention is useful for 32-bit and 128-bit computer architectures, in addition to the 64-bit Intel Itanium® architecture. In the above, third implementation representing one embodiment of the present invention, intermediate results are placed into result words as soon as they are available, but, in other implementations, all intermediate results may be placed into intermediate-result registers and moved into the result registers only upon completion of arithmetic operations. As with any implementation, there are an almost limitless number of different ways for implementing a multiple-precision multiply-and-add operation according to the present invention. Different types of control structures, different ordering of instructions, and different types of instructions available on different computer architectures may all be employed to produce a highly parallelized, efficient multiple-precision multiply-and-add operation. Moreover, although in the above described embodiment, blocks of instructions exclusively containing multiply-and-add operations are followed by blocks of instructions exclusively containing add instructions, many different instructions groupings are possible, including instruction groupings in which blocks of instructions contain both multiply-and-add instructions and add instructions, all instructions in each block lacking write dependencies and thus executable in parallel. The above-described embodiments may be straightforwardly implemented to employ only registers, or a combination of memory locations and registers for input of operands, computation of results, and storing the computed results.

The foregoing description, for purposes of explanation, used specific nomenclature to provide a thorough understanding of the invention. However, it will be apparent to one skilled in the art that the specific details are not required in order to practice the invention. The foregoing descriptions of specific embodiments of the present invention are presented for purpose of illustration and description. They are not intended to be exhaustive or to limit the invention to the precise forms disclosed. Obviously many modifications and variations are possible in view of the above teachings. The embodiments are shown and described in order to best explain the principles of the invention and its practical applications, to thereby enable others skilled in the art to best utilize the invention and various embodiments with various modifications as are suited to the particular use contemplated. It is intended that the scope of the invention be defined by the following claims and their equivalents:

1. A multiple-precision, multiply-and-add operation for handling at least one operand having more than one natural word comprising:
a first operand;
a second operand;
an addend operand;
a result vector; and
for each natural word of the second operand,
a block of multiply-and-add instructions that multiply the natural word of the second operand by all natural words of the first operand and store results of the multiply-and-add instructions as intermediate results, the block of multiply-and-add instructions that multiply the first natural word of the second operand by all natural words of the first operand additionally adding a number of initial natural words of the addend operand to the products of the first natural word of the second operand and all natural words of the first operand, the block of multiply-and-add instructions containing no write dependencies.

2. The multiple-precision, multiply-and-add operation of claim 1 wherein each block of multiply-and-add instructions contains only multiply-and-add instructions.

3. The multiple-precision, multiply-and-add operation of claim I wherein a block of multiply-and-add instructions may contain add instructions in addition to multiply-and-add instructions.

4. The multiple-precision, multiply-and-add operation of claim 1 further including:
a number of blocks of add instructions that add the intermediate results and any remaining natural words of the addend operand to produce a final result vector that contains a sum of the addend operand and a product of the first and second operands.

5. The multiple-precision, multiply-and-add operation of claim 1 wherein at least one of the first operand, second operand, and addend operand is contained within two or more registers.

6. The multiple-precision, multiply-and-add operation of claim 1 wherein at least one of the first operand, second operand, and addend operand is contained within two or more natural words in memory.

7. The multiple-precision, multiply-and-add operation of claim 1 wherein the result vector is contained within two or more registers.

8. The multiple-precision, multiply-and-add operation of claim 1 wherein the result vector is contained within two or more natural words in memory.

9. The multiple-precision, multiply-and-add operation of claim 1 wherein, because there are no write dependencies in the blocks of multiply-and-add instructions, all multiply-and-add instructions of each block can be executed together in parallel.

10. A method for multiplying a first operand by a second operand to produce an intermediate product to which an addend operand is added to produce a result in a result vector, at least one of the first operand, second operand, and addend operand having more than one natural word, the method comprising:
for each natural word of the second operand,
using a block of multiply-and-add instructions to multiply the natural word of the second operand by all natural words of the first operand and store results of the multiply-and-add instructions as intermediate results, when multiplying the first natural word of the second operand by all natural words of the first operand additionally adding a number of initial natural words of the addend operand to the products of the first natural word of the second operand and all natural words of the first operand, the block of multiply-and-add instructions containing no write dependencies.

11. The method of claim 10 wherein each block of multiply-and-add instructions contains only multiply-and-add instructions.

12. The method of claim 10 wherein a block of multiply-and-add instructions may contain add instructions in addition to multiply-and-add instructions.

13. The method of claim 10 further including:
using a number of blocks of add instructions that add the intermediate results and any remaining natural words of the addend operand to produce a final result vector that contains a sum of the addend operand and a product of the first and second operands.

14. The method of claim 10 wherein at least one of the first operand, second operand, and addend operand is contained within two or more registers.

15. The method of claim 10 wherein at least one of the first operand, second operand, and addend operand is contained within two or more natural words in memory.

16. The method of claim 10 wherein the result vector is contained within two or more registers.

17. The method of claim 10 wherein the result vector is contained within two or more natural words in memory.

18. The method of claim 10 further including executing some or all of the multiply-and-add instructions of each block of multiply-and-add instructions in parallel.

19. A multiple-precision, multiply-and-add operation for handling at least one operand having more than one natural word comprising:
a first operand;
a second operand;
an addend operand;
for each natural word of the second operand,
a means for multiplying the natural word of the second operand by all natural words of the first operand and storing results as intermediate results, the means for multiplying the natural word of the second operand by all natural words of the first operand additionally adds a number of initial natural words of the addend operand to the products of the first natural word of the second operand and all natural words of the first operand without write dependencies.
